(19) United States
(12) Patent Application Publication
(10) Pub. No.: US 2025/0303567 A1
(43) Pub. Date: Oct. 2, 2025

(54) Systems and Methods for Joint Design of Actuators and Control for Robots

(71) Applicant: Mitsubishi Electric Research Laboratories, Inc., Cambridge, MA (US)

(72) Inventors: Yebin Wang, Cambridge, MA (US); Adrian Stein, Buffalo, NY (US); Jui-Te Lin, San Diego, CA (US); Zehui Lu, West Lafayette, IN (US)

(73) Assignee: Mitsubishi Electric Research Laboratories, Inc., Cambridge, MA (US)

(21) Appl. No.: 18/622,483

(22) Filed: Mar. 29, 2024

(51) Int. Cl. B25J 9/16

(52) U.S. Cl. CPC B25J 9/1664; B25J 9/161; B25J 9/163; B25J 9/1671

(57) ABSTRACT

An engineering system comprises a memory having instructions stored thereon and at least one processor configured to execute the instructions to cause the system to collect a plurality of tasks for a manipulator actuated by a motor. Structural parameters of the motor, a plurality of reference trajectories of the motor for actuating the manipulator to perform the plurality of tasks, and parameters of a feedback control policy for the manipulator are jointly determined to increase overlap between a probability distribution of values of operational data of the motor operating according to different real trajectories from a plurality of real trajectories and an efficiency map of the motor defined in a domain of the operational data of the motor. The structural parameters of the motor, the plurality of reference trajectories, and the feedback control policy are output for performing the plurality of tasks.

### TECHNICAL FIELD

The present disclosure relates generally to robot designing and more particularly to systems and methods for jointly designing actuators and control for robotic manipulators.

### BACKGROUND

Robot design is about weighting decision variables such as structural dimensions, lengths/shapes and inertia of manipulator links, the selection of drive-trains (gearboxes and electric motors), motion (trajectories of joint movements), and controller, so that the robot meets desired needs while being cost-effective. The desired needs are typically captured by design objectives formulated in distinctive domain language, such as kinematics, weight, energy consumption, task completion time, and workspace maximization. The constraints mostly correspond to workspace; system operating conditions such as the range of end-effector forces, desired velocity and acceleration, and stress/wrench limits; and dynamic tip-over stability. The multidisciplinary nature, involving structural mechanics, kinematics, dynamics, thermodynamics, electronics and so on, renders it a highly complicated problem which has further stimulated tremendous research efforts in the past few decades.

Recent advances in robot design can be summarized as two noticeable trends: co-design of hardware and software for performance and cost-effectiveness; and customized design, i.e., encoding application information during robot design. Co-design is inspired by the realization that conventional design, performing domain-specific subsystem design separately and ignoring their dependence; and thus exploits the coupling between subsystems to improve system performance. The customized design paradigm echoes the fact that whether a given robot design is optimal depends on how/where the robot is used/deployed.

Prevailing co-design work for robotic manipulators either suffer from limited design degree of freedom or do not explicitly take high-level application-related user specifications into account. While some approaches have attempted to formulate the resultant co-design into an optimization problem, such approaches have turned out to be computationally prohibitive, and often impossible.

Accordingly, there is an impeding need for solutions that investigate a co-design problem where both the motion (trajectory) and motors of a robotic manipulator with n degrees-of-freedom are optimized concurrently for one or more specific applications.

### SUMMARY

Some embodiments are directed towards solutions for efficiently solving a multi-task co-design problem. It is an objective of some embodiments to provide a sequential co-design strategy that incorporates a probabilistic approach for jointly computing trajectories and designing motors based on efficiency. Some embodiments approach the co-design problem by identifying multiple motor designs through optimization of motions and motors for multiple tasks one by one and then reconciling them to determine the final motor design. Some embodiments utilize magnetic equivalent circuit modeling to establish the analytical mapping from motor design parameters to dynamic model parameters that enables an efficient differentiable simulator. Also, some embodiments provide a direct-collocation-based differentiable simulator of motor and robotic arm dynamics to balance computation complexity and numerical stability, allowing for gradient-based optimization.

It is a realization of several embodiments that conventional motion-control systems suffer from the drawback of lack of flexibility and unsatisfactory performance, at least in part, due to the fixed and decoupled design of the mechanical subsystem and the control subsystem. During the operation of such systems, it is difficult or even impossible to change at least some of those parameters, i.e., the system has a fixed electromechanical design. Accordingly, available options for optimizing the operation of such motion-control systems are few and mostly limited to conventional control methods running in the control module to command controllable actuators of such systems.

It is a recognition of some embodiments that optimizing the operation of the motion-control machine is dependent upon the understanding that different tasks of the machine might be better optimized for different designs of the machine. But the design of the machine is usually predetermined independently of the specific future tasks the machine will perform. However, some embodiments are based on the realization that in several real-world applications, redesigning the mechanical subsystem and the control subsystem online for different tasks or criteria may be desired. In this regard, while some approaches concentrate on co-design of hardware and software for performance and cost-effectiveness, the has also been some attempt to provide customized designs encoding application information during robot design.

Through extensive research and experimentation, some embodiments realized that one of the main challenges in co-design for a certain application, characterized by multiple tasks, is heavy computational burden. Accordingly, it should not come as a surprise that most of the prevalent co-design works impose a restriction on the number of axes or motor design freedom. This is also supported by the realization of several embodiments that most existing works only consider the selection of motor mass and inertia during robot design.

Accordingly, some embodiments propose the co-designing of the motions (joint trajectories), motors, and a feedback control compensator for an n degrees-of-freedom (DOF) robotic manipulator to achieve optimal system performance while encoding the application information explicitly. The application may be characterized by a set of tasks which in turn may be predefined or specified by users. The design variables for motion are the control input u(t) of the robot over time; the design variable for motors are key geometry parameters parameterized by Θ representing the motor permanent magnet thickness, tooth width, slot opening, tooth height, etc.; and the design variables Θ_{c} for the feedback control compensator are constant controller gains.

Some embodiments provide an iterative and sequential co-design framework, where during each iteration, beginning with a motor design, reference trajectory planning is solved to obtain reference trajectories x*(t) or u*(t) for all tasks one by one based on an ideal dynamic model of the robot, feedback control policy is determined by assessing the trajectory tracking performance where a non-ideal differentiable robot simulator is instructed to follow the reference trajectories, and motor design is updated according to the measured (or real) trajectories x(t), u(t) of the non-ideal differentiable robot simulator.

Some embodiments are based on the principles of ‘operational probability distribution’, a probability distribution of operating data of each motor in the torque-speed plane to represent the characteristics of user-specific application based on the specification of multiple tasks. This concept avoids solving trajectory planning of all tasks at once and thus reduces the computational complexity. Also, it allows to decouple the motor design from the trajectory planning and feedback control policy design, and the motor design step yields a unique motor design. Based on the output real trajectories of the non-ideal differentiable robot simulator, a probability distribution (operational probability distribution) of operating data for each motor of each axis on the speed-torque plane may be constructed. Motor design is to search for the best motor design variables Ξ* by maximizing the overlap between the operational probability distribution p(ω, τ) and the efficiency distribution η(ω, τ) (efficiency map) of the motor. Here speed is denoted by ω and torque is denoted by τ. The cost function of the motor design is:

$${J}_{m} ( {Θ}_{m} ) = {\int }_{\underline{ω}}^{\overline{ω}} {\int }_{\underline{τ}}^{\overline{τ}} p ( ω , τ ) η ( ω , τ ) d ω d τ ,$$

where Ξ is the vector of motor design variables, ω̅, ω are the upper bound and lower bound of the motor speed, respectively, and ω̅, ω are the upper bound and lower bound of motor torque, respectively. In order to achieve efficient optimization during the motor design, some embodiments incorporate a modeling method which allows modelling of the motor efficiency η(ω, τ) as an analytical function of design variables: η(ω, τ, Ξ) at each operating point. The analytical modeling of the motor efficiency allows the auto-differentiation tools to compute the gradient and Hessian based on symbolic computation, which facilities gradient-based optimization solvers for this problem.

Some embodiments also lead to establishment of the motor efficiency as an analytical function η(ω, τ, Ξ) based on the dynamic model of motor which contains model parameters such as ξₘₒₜₒᵣ=[L, Φₘ, R]^{T} etc. Some embodiments also employ magnetic equivalent circuit modeling, which maps Ξ, representing motor geometry design parameters, to the parameters of the motor dynamic model.

Some embodiments realized that in contrast to the state-of-the-art, which chooses motors from a product catalog and assess the design for a single motion task, a better and efficient approach can involve the design of motor geometry and motion for an application characterized by a set of tasks. Such an approach achieves higher performance for a specific application compared to conventional worst-case design, which does not employ either application information or co-design ideas.

Towards these ends, it is an objective of some example embodiments to provide systems, methods and computer program products for generating design data for a manipulator. The design data may be utilized for selecting a suitable control law to control the manipulator. According to some embodiments, the design data may be utilized for redesigning the manipulator to perform one or more given tasks.

Accordingly, some example embodiments provide an engineering system comprising a memory having instructions stored thereon and at least one processor configured to execute the instructions to cause the system to collect a plurality of tasks for a manipulator actuated by one or multiple actuators including a motor. The processor is further configured to determine, jointly and in interdependence on each other, structural parameters of the motor, a plurality of reference trajectories of the motor for actuating the manipulator to perform the plurality of tasks, and parameters of a feedback control policy for the manipulator. The structural parameters of the motor, the plurality of reference trajectories, and the parameters of the feedback control policy are jointly determined to increase overlap between a probability distribution of values of operational data of the motor operating according to different real trajectories from a plurality of real trajectories and an efficiency distribution of the motor defined in a domain of the operational data of the motor. The processor is further configured to output the structural parameters of the motor, the plurality of reference trajectories, and the feedback control policy.

In yet another example embodiment, a computer-implemented method for jointly designing actuators and control for a robotic manipulator is provided. The method comprises collecting a plurality of tasks for the manipulator actuated by one or multiple actuators including a motor. The method also comprises determining, jointly and in interdependence on each other, structural parameters of the motor, a plurality of reference trajectories of the motor for actuating the manipulator to perform the plurality of tasks, and parameters of a feedback control policy for the manipulator. The structural parameters of the motor, the plurality of reference trajectories, and the parameters of the feedback control policy are jointly determined to increase overlap between a probability distribution of values of operational data of the motor operating according to different real trajectories from a plurality of real trajectories and an efficiency distribution of the motor defined in a domain of the operational data of the motor. The method further comprises outputting the structural parameters of the motor, the plurality of reference trajectories, and the feedback control policy.

In yet some other example embodiments, a non-transitory computer readable medium having stored thereon computer executable instructions for performing a method for jointly designing actuators and control for a robotic manipulator is provided. The method comprises collecting a plurality of tasks for the manipulator actuated by one or multiple actuators including a motor. The method also comprises determining, jointly and in interdependence on each other, structural parameters of the motor, a plurality of reference trajectories of the motor for actuating the manipulator to perform the plurality of tasks, and parameters of a feedback control policy for the manipulator. The structural parameters of the motor, the plurality of reference trajectories, and the parameters of the feedback control policy are jointly determined to increase overlap between a probability distribution of values of operational data of the motor operating according to different real trajectories from a plurality of real trajectories and an efficiency distribution of the motor defined in a domain of the operational data of the motor. The method further comprises outputting the structural parameters of the motor, the plurality of reference trajectories, and the feedback control policy.

### BRIEF DESCRIPTION OF THE DRAWINGS

The presently disclosed embodiments will be further explained with reference to the following drawings. The drawings shown are not necessarily to scale, with emphasis instead generally being placed upon illustrating the principles of the presently disclosed embodiments.

FIG. 1A illustrates a method for jointly designing actuators and control for a robotic manipulator, according to some embodiments.

FIG. 1B illustrates schematics of a robotic manipulator, in accordance with some example embodiments;

FIG. 1C illustrates schematics of a joint assembly of the robotic manipulator of FIG. 1B, in accordance with some example embodiments;

FIG. 1D illustrates a robotic arm performing a typical task, according to some embodiments;

FIG. 1E illustrates a robot control system for the manipulator of FIG. 1B to perform a certain positioning task, according to some embodiments;

FIG. 2A illustrates a flowchart of an exemplar method for joint design of motors, tracking controller, and motion planner for a given application, according to some embodiments;

FIG. 2B illustrates an algorithm for the method of FIG. 2A for closed loop co-design framework for the robotic manipulator, according to some embodiments;

FIG. 3 illustrates some contents of differentiable modeling utilized by a robot control system, according to some embodiments;

FIG. 4A illustrates some steps of a method of motor modeling 305, according to some embodiments;

FIG. 4B illustrates an embodiment of design parameterization of a motor's 2D geometry, according to some embodiments;

FIG. 4C illustrates some steps of a method for deriving various losses as a part of efficiency modelling of the motor, according to some embodiments;

FIG. 5A illustrates some steps of a method for updating robot arm dynamics, according to some embodiments;

FIGS. 5B-5D jointly illustrate an algorithm for implementing a differentiable simulator, according to some embodiments;

FIG. 6A illustrates a method of determining reference motion trajectory for each task of an application by solving various motion planning problems, according to some embodiments;

FIG. 6B illustrates a method for obtaining motion trajectories for all tasks of the application, according to some embodiments;

FIG. 7A illustrates a method for feedback control policy synthesis, according to some embodiments;

FIG. 7B illustrates a block diagram of a tracking controller of the robot control system of FIG. 1E, according to some embodiments;

FIG. 8A illustrates a method for updating motor design, according to some embodiments;

FIG. 8B illustrates a method for discretization of the motor design optimization problem of FIG. 8A, according to some embodiments;

FIG. 9 illustrates two plots: one showing operational distribution of a motor on the speed-torque plane and the other showing the discretized counterpart of the operational distribution of the motor on the speed-torque plane, according to some embodiments; and

FIG. 10 illustrates some components of an engineering system for joint designing of motors, tracking controller, and motion planner for a given application defined as set of tasks, according to some embodiments.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like-reference numbers and designations in the various drawings may indicate like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

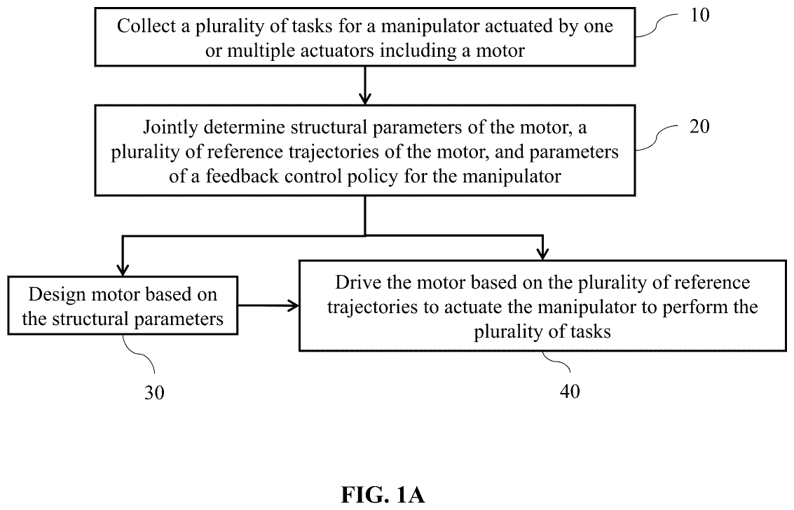

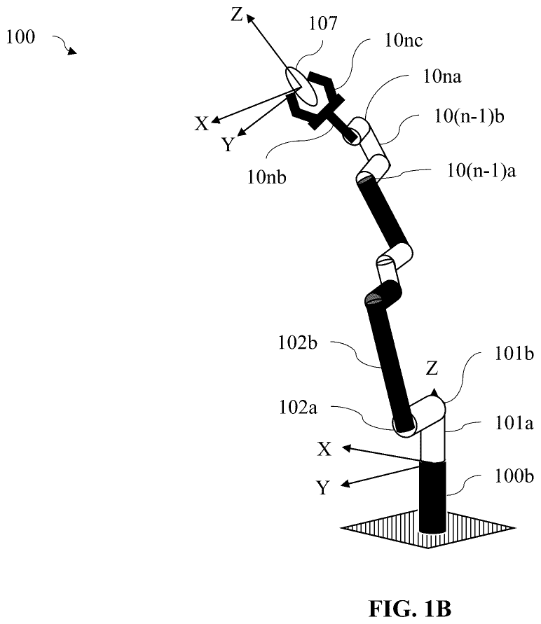

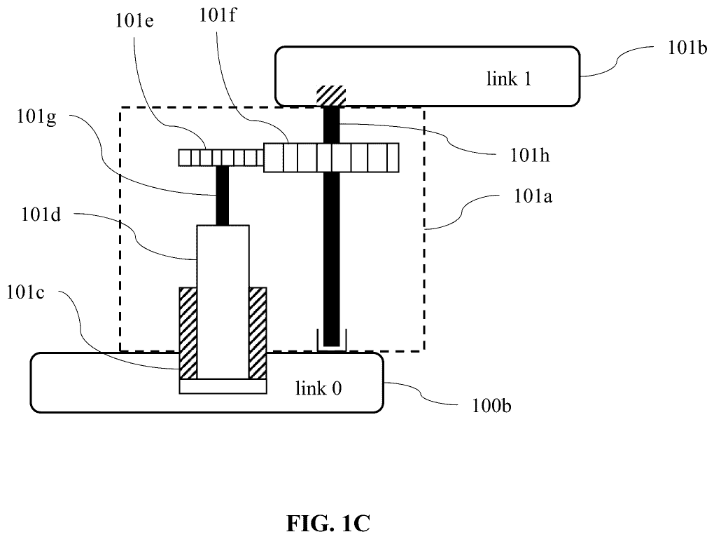

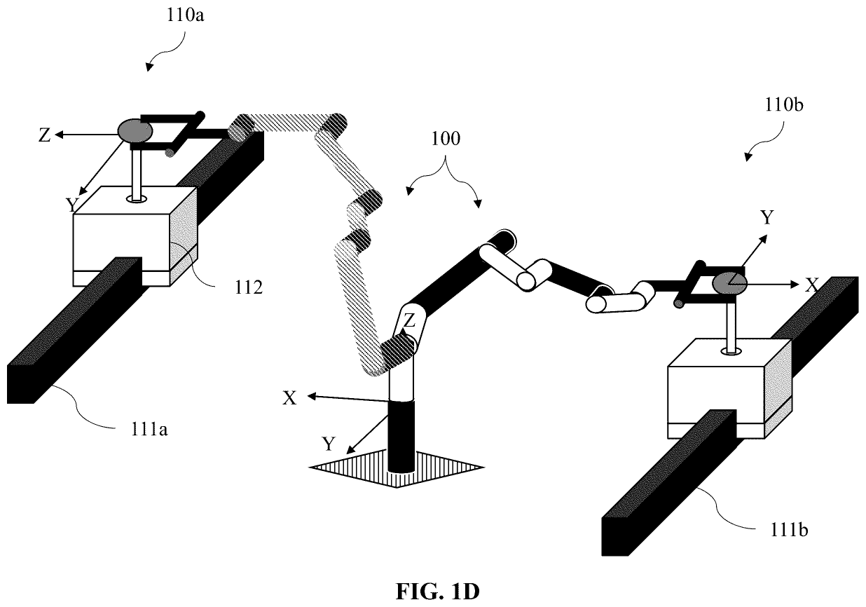

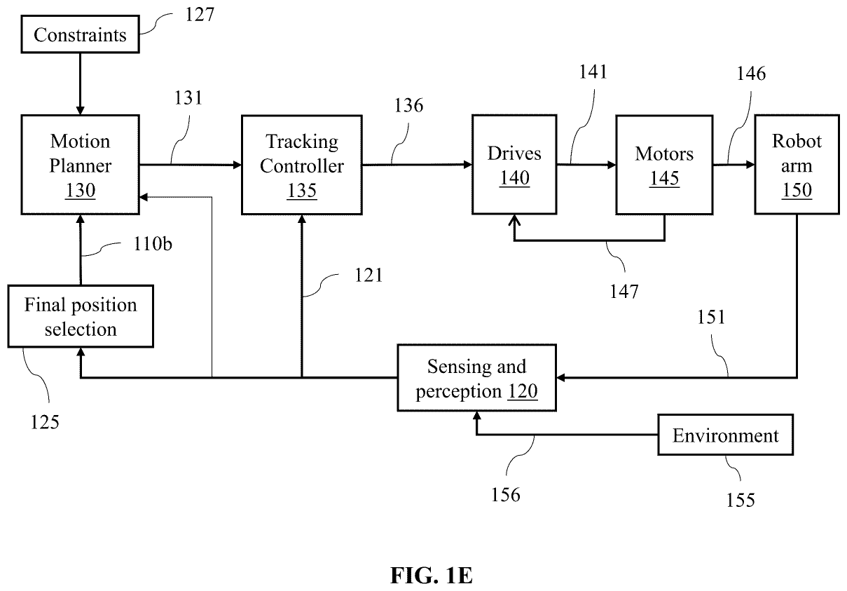

FIG. 1A illustrates a method for jointly designing actuators and control for a robotic manipulator, according to some embodiments. The method comprises collecting 10 a plurality of tasks for the manipulator. The manipulator may be actuated by one or multiple actuators including a motor. Structural parameters of the motor, a plurality of reference trajectories of the motor for actuating the manipulator to perform the plurality of tasks, and parameters of a feedback control policy for the manipulator may be determined 20 jointly and in interdependence on each other. The structural parameters of the motor, the plurality of reference trajectories of the motor, and the parameters of the feedback control policy for the manipulator are jointly determined to increase overlap between a probability distribution of values of operational data of the motor operating according to different real trajectories and an efficiency distribution of the motor defined in a domain of the operational data of the motor. The real trajectories are produced by a manipulator control system. The structural parameters of the motor, the plurality of trajectories, and the feedback control policy determined at step 20 may be output for performing the plurality of tasks. In this regard, the method comprises designing 30 the motor based on the determined structural parameters and driving 40 the designed motor based on the plurality of reference trajectories to actuate the manipulator to perform the plurality of tasks. Towards this end, the reference trajectories may be computationally executed to actuate the manipulator. Also, control commands for the motor are generated as per the parameters of the control policy such that the control commands cause the motor to actuate the manipulator in a manner that the manipulator follows the plurality of reference trajectories.

Some example embodiments provide systems and methods for jointly designing and control of a class of n degree-of-freedom (DOF) open-chain manipulator such as the manipulator 100 illustrated in FIG. 1B. The manipulator 100 comprises a base 100b, multiple joints, multiple links and an end-effector 10nc where each joint may typically move in one or more directions. The manipulator 100 may be used to perform one or more tasks such as manipulating a payload 107. The specific task may be defined in terms of parameters including, e.g., an initial position and velocity of the payload, a final position and velocity of the payload, acceleration and velocity constraints on the payload, time to accomplish the task, and the like. The manipulator 100 may be electronically coupled to a control system that provided control inputs to execute the task. An interface may be utilized to receive or collect one or more tasks. According to some embodiments, the base 100b may be mountable on a surface such as the floor or a movable platform. The other end of the base 100b is mechanically coupled with a first-axis link 101b through a first-axis joint 101a. The first-axis link 101b is coupled with a second-axis joint 102a, which is connected to a second-axis link 102b. This coupling and connection patterns are repeated until reaching the end-effector 10nc, which is attached on a last-axis link 10nb. The last-axis link 10nb is coupled with a previous link 10(n−1)b through a last-axis joint 10na. According to some embodiments, one or more components of the manipulator 100 may be modeled in any suitable manner such as in terms of mathematical equations and a corresponding model of the components may be accessible to the control system of the manipulator 100. Each such model may describe interaction between various variables pertaining to the corresponding component such as control input variables, state variables (for example position, orientation, heading etc.).

In some embodiments, a joint of the manipulator 100 may be of any suitable type including but not limited to: revolute, prismatic, helical etc. The movements of the joints of the manipulator 100 may be controlled by one or more actuators coupled to the joints such that the manipulator 100 can be moved in accordance with one or more control inputs to effectuate manipulation of the payload 107 along any dimension.

According to some embodiments one or more joints such as the first-axis joint 101a may be a revolute type. FIG. 1C illustrates the schematics of the first-axis joint 101a of type revolute for illustration purpose. The base 100b may also be referred to as the link 0. The revolute joint 101a houses an electric motor comprising a stator 101c and a rotor 101d, and a gearbox assembly consisting of two gears 101e and 101f. Particularly, the stator 101c is rigidly attached on link 0 and always moves along with link 0, whereas the rotor 101d, along with the gear 101e, rotates around their axis 101g. The gear 101e drives gear 101f which rotates around its axis 101h. Because the axis 101h is rigidly attached to first-axis link 101b (also referred to as link 1), the link 101b also rotates around the axis 101h at the same angular velocity as the gear 101f. The motion of rotor 101d is driven by a torque arising from the electromagnetic interaction between stator and rotor.

In some embodiments, the electric motor is of type of surface-mounted permanent magnet synchronous motor (SPMSM), where the electromagnetic interaction between stator and rotor is implemented by supplying certain voltages to the windings of stator, whereas the rotor may comprise multiple permanent magnet pieces.

According to some embodiments, the manipulator 100 may be a robot arm, which is a combination of joints, links and gearboxes, and multiple motors. Such a robot arm may be configured to move objects or payloads from an initial position to a desired final position. FIG. 1D illustrates an exemplary robot arm for loading/unloading a workpiece onto/from a conveyor, according to some embodiments. As shown in FIG. 1D, the manipulator may be used to load a workpiece 112 onto a convey belt 111a, or unload finished parts off the convey belt, or move a workpiece between convey belts 111a and 111b, or moves the end-effector along a designated path. In some embodiments, the usage of manipulator 100 involves moving a workpiece from one initial position 110a to final position 110b.

FIG. 1E shows one embodiment of a robot control system for the manipulator 100 to perform a certain positioning task. The positioning task may comprise moving the end-effector of the manipulator 100 from an initial position 110a of FIG. 1D to final position 110b of FIG. 1D. A sensing and perception module 120 senses signals reflecting the operational status 151 of the robot arm 150 (the hardware part of manipulator 100) and state 156 of the environment 155, processes the signals, and outputs 121 to each of a tracking controller 135 and a final position selection module 125. The final position selection module 125 processes the measured signals 121 to determine the final position 110b and sends it to a motion planner 130. The motion planner 130 computes a reference motion trajectory 131 of the robot arm so that while following the reference motion trajectory, the end-effector 10nc shown in FIG. 1B moves from its initial position (or pose) and arrives at the final position (pose). In some embodiments, the initial position is the position of the robot arm before the execution of the motion task. The tracking controller 135 receives measured signals 121 and the reference trajectory 131 and determines one or more control commands 136, which is fed into drives 140. The drive units 140 further generate voltages supplied to motors 145. With the supplied voltages 141, the motors 145 produce electromagnetic torques 146, which move joints and links so that the movement of the end-effector of the robot arm 150 follows the reference trajectory 131 accurately.

In some embodiments, the final position 110b may be predefined or specified by a user/operator and pre-coded in software, and thus may be independent from sensing and perception module 120 and environment 155. The drive unit 140 may be realized in the form of an inverter-a kind of power electronics which converts a DC power into an AC power according to the command input 136. The motors 145 may be of surface-mounted permanent magnet motor (SPMSM) type where it contains three-phase windings in its stator. The three-phase SPMSM is supplied with three-phase voltages from the drive unit 140.

In some embodiments, the reference motion trajectory 131 of the robot arm may be represented by the trajectories of angles of all joints.

In some embodiments, the sensing and perception module 120 measures the currents flowing through motors 145 at all joints, the angles of rotors of all motors 145, etc., and thus signal 121 comprises motor currents and angular positions of motor rotors. The sensing and perception module 120 may also sense the environment by suitable sensors such as but not limited to a camera, LiDAR, or microphone to detect location of static obstacles or movements of dynamic obstacles. Hence, signal 121 may also include locations, sizes, shapes, and bounding boxes of objects in environment which might critically impact the motion generation and/or its execution toward accomplishment of a certain task.

In some embodiments, the control command 136 provided to the drives 140 may be in the form of reference torques to be produced by the motors 145. In some embodiments, the drive unit 140 determines and outputs the three-phase voltages needed by the motors 145.

In some embodiments, it may be an objective of the manipulator 100 to complete a task as fast as possible (i.e., within a threshold time period). In some other embodiments, it may be an objective to complete a task within a fixed amount of time while minimizing the energy consumption (i.e., with a threshold energy expenditure). Accordingly, some embodiments are directed towards solutions that jointly design the motors 145, the tracking controller 135, and the motion planner 130 toward accomplishment of one or multiple tasks.

According to some embodiments, the one or more tasks may constitute a given application that may be specified by operators or other machines coupled to the manipulator 100. In some embodiments, the joint design of motors, tracking controller, and motion planner for a given application may be formulated as a constrained optimization problem and solved efficiently. The constrained optimization problem involves characterizing user specification in a mathematically rigorous way to be absorbed into the optimization problem, modeling and simulation of the manipulator, devising an optimization process, control policy synthesis, and optimization algorithms.

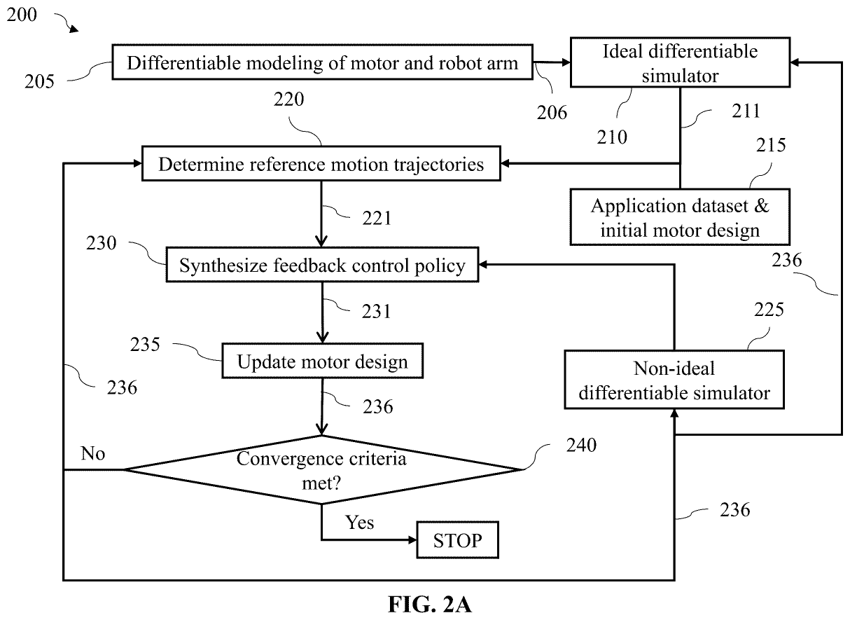

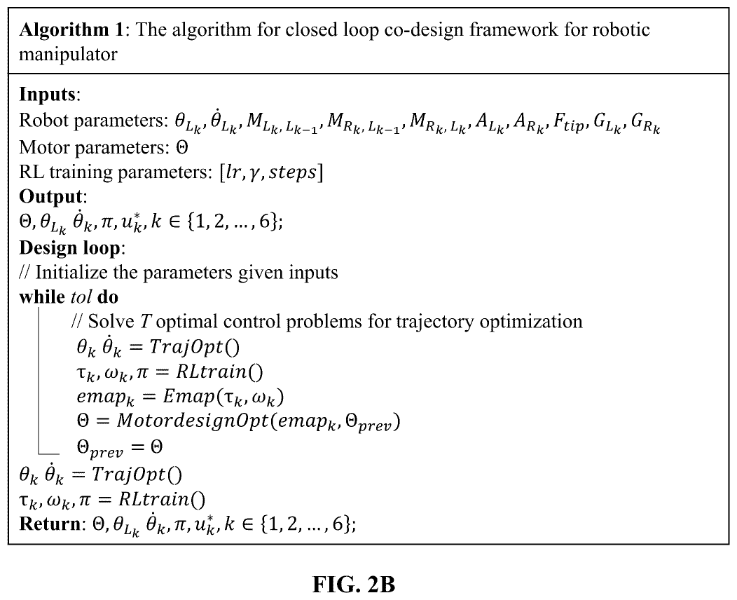

FIG. 2A illustrates a flowchart of an exemplar method 200 for joint design of motors, tracking controller, and motion planner for a given application, according to some embodiments. The method 200 comprises differentiable modeling 205 of motors and the robot arm to establish the analytical mapping from decision variables (including motor design parameters and motion trajectories of joints or links or robot arm) to the models of motors and robot arm, constraints, and cost functions. The method 200 further comprises developing 210 an ideal differentiable simulator 211 based on differential models 206 as a result of the differentiable modeling 205. Application dataset may be characterized 215 to generate an initial motor design. The method 200 also comprises determining 220 the reference motion trajectories 221 and synthesizing 230 with the given the reference motion trajectories 221, a feedback control policy based on a non-ideal differentiable simulator 225.

The output 231 from the synthesizing step 230 includes the measured signals 121 of the closed-loop robot control system combining feedback control policy and the non-ideal differentiable simulator 225. The output 231 is used to update 235 the motor design. At 240, if convergence criteria is met, then the optimization process stops and outputs the last motor design 236 updated at step 235, otherwise, the last motor design 236 is fed back into module 220 and the steps of determining 220, synthesizing 230, and updating 235 are repeated. Both the ideal differentiable simulator 210 and the non-ideal differentiable simulator 225 are initialized with the initial motor design but are updated according to the last motor design produced at step 235 in each iteration. FIG. 2B illustrates an algorithm for the method 200 of FIG. 2A for closed loop co-design framework for the robotic manipulator.

In some embodiments, the convergence criteria typically reflect the differences between latest motor design and previous motor design. For instance, if the motor design is parameterized by a real vector ξ, then the criteria can be defined as the sum of squares of ξₖ−ξₖ₋₁, where ξₖ, ξₖ₋₁ denote the latest motor design and previous motor design, respectively.

Notations used in motor modeling are summarized in Table 1.

### Notations Used in the SPMSM Model

| Notation | Description |
|---|---|
| ω | rotor speed |
| Φₘ | permanent magnet flux |
| i_{d}, i_{q} | current in d- and q-axis |
| u_{d}, u_{q} | voltage in d- and q-axis |
| L_{d}, L_{q} | inductance in d- and q-axis |
| P | number of pole pairs |
| R | winding resistance |
| J | rotor inertia |
| τ | load torque |

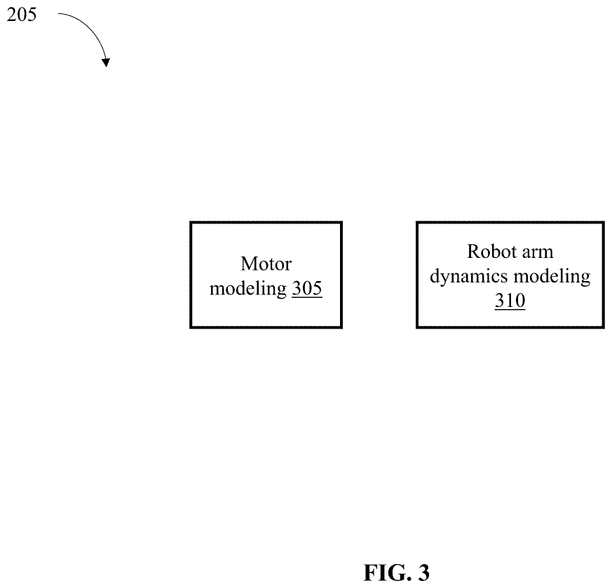

Some embodiments are directed towards differentiable modeling for both motors and robot arm to analytically capture the relationship between decision variables and all equations and cost functions involved in the determination of reference motion trajectories 220, the synthesis of feedback control policy 230, and the update of motor design 235. FIG. 3 shows one embodiment of the differentiable modeling 205, which contains motor modeling 305 and robot arm dynamics modeling 310.

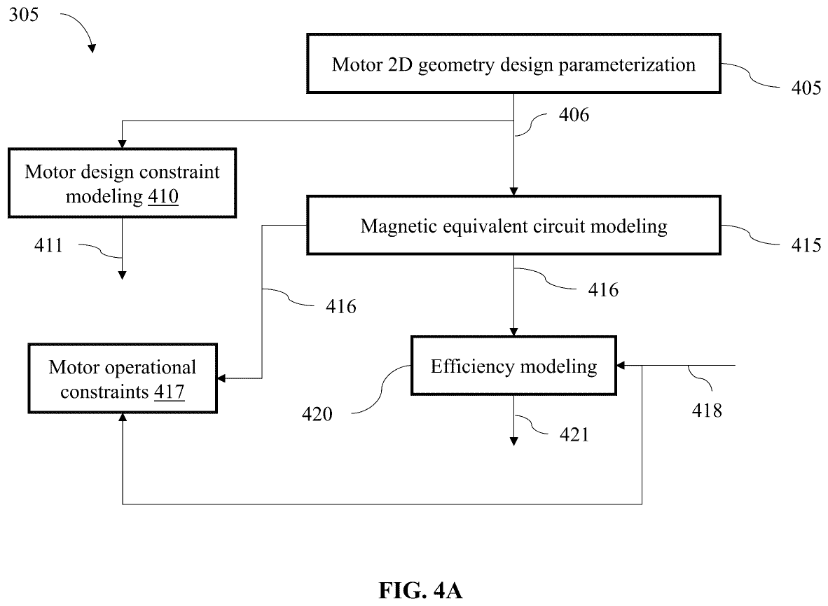

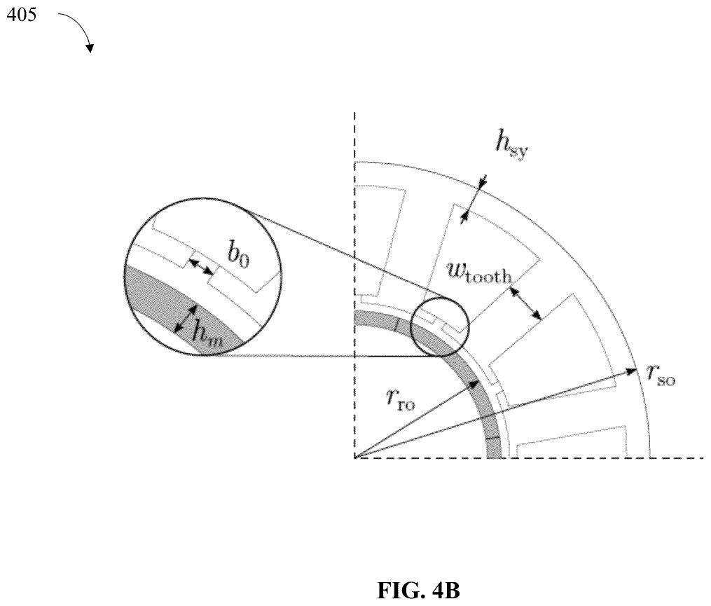

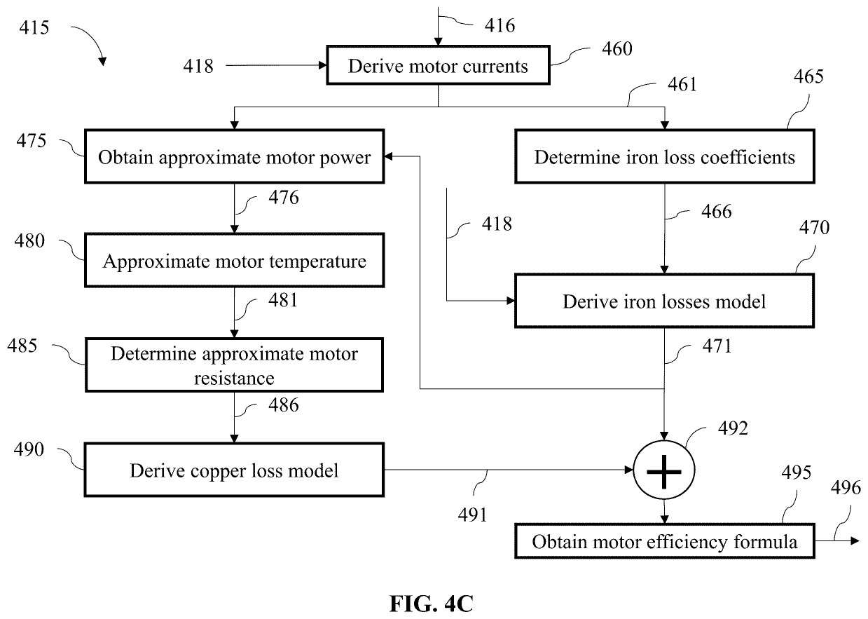

FIG. 4A discloses some steps of a method of motor modeling 305. The design parameterization 405 of the motor 2D geometry may be performed. Given the design parameterization 406 as ξ, both motor design constraint modeling 410 and magnetic equivalent circuit modeling 415 may be conducted where the former outputs the design constraints as a set of nonlinear algebraic equations 411 and the latter outputs a dynamic model 416 of the motor with electrical circuit parameters ξₘₒₜₒᵣ=[L, Φₘ, R]^{T}. Given the motor dynamic model 416 and operation point 418, the motor operational constraints 417 can be derived and the efficiency modeling 420 can be performed to obtain the efficiency model of the motor 421.

FIG. 4B illustrates one embodiment of the design parameterization 405 of the motor 2D geometry. The design parameters 406 are denoted by ξ=[L, rᵣₒ, rₛₒ, hₘ, h_{sy}, wₜₒₒₜₕ, b₀]^{T}. Particularly, L is the axial length of core, rᵣₒ the outer radius of rotor, rₛₒ the outer radius of stator, hₘ the height of magnet, h_{sy} the stator yoke, wₜₒₒₜₕ the width of tooth, and b₀ the slot opening. According to some embodiments, the other design parameters (not shown in FIG. 4B) may be kept constant, particularly:
Number of pole pairs P=4
Number of slots Q=12
Height of tooth tip hₜᵢₚ=2 mm
Width of air gap δ=0.5 mm
Number of winding turns per tooth nₛ=50
Number of coils connected in parallel C=1
Remanent flux density of the magnet Bᵣ=1.38 T
Relative recoil permeability of the magnet μᵣ=1.05
Filling factor f_{f}=0.55
Maximum limitation for flux density Bₘₐₓ=1.5 T
Magnet width in electric angle αₘ=π

In some embodiments, the motor may be assumed with zero skewness, which yields a slot/pole ratio of 12/8 and a winding factor of k_{w1}=0.866. Table 2 lists an example of the nominal values, units, and bounds of variables in ξ.

Motor geometry design variables ξ.

| Parameter | Nominal Value | Unit | Bounds [ξ_{lb}, ξ_{ub}] |
|---|---|---|---|
| L | 20 | mm | [20, 100] |
| Rᵣₒ | 18 | mm | [10, 100] |
| Rₛₒ | 30 | mm | [10, 100] |
| hₘ | 3 | mm | [1, 5] |
| h_{sy} | 5 | mm | [5, 10] |
| wₜₒₒₜₕ | 7 | mm | [5, 20] |
| b₀ | 2 | mm | [1, 10] |

Referring back to FIG. 4A, in some embodiments, motor design constraint modeling 410 reflects the restrictions on material cost, motor weight limit, and geometry compatibility. Given design parameters 406, the cylindrical rotor weight can be calculated as mᵣₒₜₒᵣ=ρᵢᵣₒₙπRᵣₒ²L. Assuming a rectangular tooth cross-sectional area, the slot width is

$${b}_{s s} = \frac{{A}_{slot}}{{h}_{s s}}$$

where:

$${A}_{s l o t} = \frac{π ( {( {R}_{s o} - {h}_{s y} )}^{2} - {( {R}_{r o} + δ + {h}_{t i p} )}^{2} )}{Q} - {w}_{tooth} {h}_{ss} ,$$

and hₛₛ=Rₛₒ−h_{sy}−Rᵣₒ−δ−hₜᵢₚ is the slot height. Given filling factor f_{f}, the copper area can be calculated as A_{cu}=Aₛₗₒₜf_{f}. For a concentrated winding type and assuming that one winding is a complete turn around a tooth, a single coil area is

$${A}_{coil} = \frac{{A}_{c u}}{2 {n}_{s}} .$$

The stator weight is thus given by:

$${m}_{s t a t o r} = {ρ}_{i r o n} L ( π ( {R}_{s o}^{2} - {R}_{r o}^{2} ) - {A}_{c u} Q ) + {ρ}_{c u} {A}_{coil} {L}_{coil} {n}_{s} Q .$$

In some embodiments, the motor design constraint modeling 410 leads to the following design constraints 411 on material cost and compatibility of dimension:

$${ξ}_{l b} \leq ξ \leq {ξ}_{u b} \qquad ( 1 )$$

$$\frac{{w}_{tooth} + {b}_{0}}{( {R}_{ro} + δ )} \leq \frac{2 π}{Q}$$

$${h}_{s s} > 0$$

$${m}_{stator} + {m}_{rotor} \leq {m}_{u b}$$

$${A}_{coil} \geq {A}_{coil , ub}$$

$$\frac{{k}_{p} {Φ}_{m}}{{w}_{t ooth} L} \leq {B}_{max} , \frac{1}{\sqrt{3}} \frac{{k}_{p} {Φ}_{m}}{{h}_{s y} L} \leq {B}_{max} ,$$

where m_{ub} and A_{coil,ub} are certain positive constants and kₚ=sin(πP/Q). The second inequality in (1) restricts the maximum tooth width and slot opening. The last inequalities in (1) caps the magnetic fluxes in both tooth and stator yoke.

According to some embodiments, magnetic equivalent circuit modeling 415 is performed as follows, based on the design parameters 406. The resistance of phase winding may be calculated as

$$R = \frac{{q}_{1}}{{C}^{2}} {R}_{1} ,$$

where

$${q}_{1} = \frac{Q}{m}$$

is the slots per phase (in this work m=3),

$${R}_{1} = \frac{{n}_{s}^{2} {ρ}_{e} {L}_{coil}}{{A}_{slot} {f}_{f}}$$

is the resistance per tooth and L_{coil} is the coil length. We know L_{coil}=2 (L+L_{end,av}), where

$${L}_{end , av} = \frac{1}{2} ( {w}_{tooth} ( 2 - \frac{π}{2} ) + \frac{{πτ}_{s}}{2} )$$

is the average length of the end-winding of the coil and

$${τ}_{s} = \frac{2 π ( {R}_{r o} + δ )}{Q}$$

is the arc span per slot.

Given Carter's coefficient

$${k}_{C} = \frac{{t}_{pitch}}{{t}_{p itch} - γδ}$$

where

$$γ = \frac{{( {b}_{0} / δ )}^{2}}{5 + {b}_{0} / δ} and$$

$${t}_{pitch} = \frac{2 π {R}_{r o}}{Q} ,$$

the magnetic flux density across the air-gap may be expressed as

$${B}_{g} = {B}_{r} \frac{{h}_{m} / {μ}_{r}}{{h}_{m} / {μ}_{r} + δ {k}_{C}} .$$

The flux density of the first harmonics is B_{g,1}=4B_{g}/π and the flux per tooth per single turn is

$${Φ}_{1} = {B}_{g , 1} \frac{2 π {R}_{r o}}{Q} L .$$

Without skewness, the flux linkage is given by

$${Φ}_{m} = {k}_{w} \frac{{q}_{1}}{c} {n}_{s} {Φ}_{1} ,$$

where k_{w}=kₚk_{d} is the winding factor with

$${k}_{d} = \frac{sin ( π / 6 )}{{q}_{p m} sin ( π / ( 6 {q}_{p m} ) )} \cdot {q}_{p m} = \frac{{q}_{1}}{gcd ( {q}_{1} , 2 P )}$$

is the slots per pole per phase and gcd(⋅) means the great common divisor.

The inductance is given by

$${L}_{d} = \frac{{q}_{1}}{{c}^{2}} {n}_{s}^{2} {L}_{turn} ,$$

where Lₜᵤᵣₙ=p_{g}+3pₛₒ+3pₜₜ is the inductance per turn and per tooth. Here p_{g} and pₛₒ, and pₜₜ, denoting the permeance of the magnetic path across the air gap and the slot opening, and the permeance of the curved magnetic path from tip to tip, respectively, are given by:

$${p}_{g} = \frac{2 π {R}_{ro} {μ}_{0} L}{( δ + \frac{{h}_{m}}{{μ}_{r}} ) Q} , {p}_{so} = \frac{{μ}_{0} {h}_{tip} L}{{b}_{0}} , {p}_{tt} = \frac{{μ}_{0} ( δ + {h}_{m} ) L}{\frac{π}{2} ( δ + {h}_{m} )} .$$

In some embodiments, the magnetic equivalent circuit modeling 415 based on design parameters 406 leads to the motor dynamic model 416 as follows:

$${i}_{d} = - \frac{1}{{L}_{d}} ( R {i}_{d} - P ω {L}_{q} {i}_{q} - {u}_{d} ) \qquad ( 2 )$$

$${i}_{q} = - \frac{1}{{L}_{q}} ( R {i}_{q} + P ω ( {L}_{d} {i}_{d} + {Φ}_{m} ) - {u}_{q} )$$

$$J \dot{ω} = {τ}_{e} - τ ,$$

where i_{d} and i_{q} are the motor currents in d- and q-axis, respectively, u_{d} and u_{q} are the voltages in d- and q-axis, respectively, w is the motor's mechanical speed, Φₘ is the permanent magnetic flux, J is the rotor inertia, τₑ is the electric torque produced by the motor and is given by

$${τ}_{e} = 1.5 P ( {Φ}_{m} {i}_{q} + ( {L}_{d} - {L}_{q} ) {i}_{d} {i}_{q} ) ,$$

τ is the load torque exerted on the rotor shaft, R is the stator winding resistance, L_{d}, L_{q} are the inductance in d- and q-axis, respectively, and P is the number of pole pairs. For SPMSM, L_{d}=L_{d}, and thus the electric torque is rewritten as τₑ=1.5Φₘi_{q}.

The differentiable modeling 305 illustrated in FIG. 4A allows to establish the motor dynamic model parameters ξₘₒₜₒᵣ to be represented as analytical functions of motor design parameters ξ. That is ξₘₒₜₒᵣ(ξ).

In some embodiments, a motor is subject to the following operational constraints 417 on currents and voltages:

$${i}_{d}^{2} + {i}_{q}^{2} \leq {i}_{u b}^{2} \qquad ( 3 )$$

$${u}_{d}^{2} + {u}_{q}^{2} \leq {u}_{u b}^{2} .$$

where subscript ub stands for upper bound, i_{ub} and u_{ub} are certain positive constants.

In some embodiments, the operation point 418 of a motor may be represented by (ω, τₑ, u_{ub}, i_{ub}). Referring to FIG. 4A, some embodiments utilize efficiency modeling 420 which derives the efficiency (equivalently power loss) model in the form of an analytical function of electric parameters ξₘₒₜₒᵣ=(L, Φₘ, R) in the motor dynamic model 416, geometry design ξ, for any given operation point 418. In some embodiments, the efficiency modeling is based on the efficiency formula given by:

$$η = \frac{{P}_{mech}}{{P}_{mech} + {P}_{cu} + {P}_{hyst} + {P}_{eddy}} , \qquad ( 4 )$$

where P_{mech} is mechanical power, P_{cu}=R(i_{d}²+i_{q}²) copper losses, P_{hyst} eddy current losses and P_{eddy} hysteresis losses. The eddy current and hysteresis losses are referred to as iron losses. If the operation point is feasible, the mechanical power is P_{mech}=τₑω, otherwise, P_{mech}=0.

FIG. 4C illustrates some steps of a method for deriving the copper losses P_{cu}=R(i_{d}²+i_{q}²), eddy current losses P_{hyst} and hysteresis losses P_{eddy} for any given operation point 418, as a part of the efficiency modelling 420, according to some embodiments. The losses may be derived for any operation point 418 based on the motor dynamic model 416, and by assuming that the motor operates at steady state. The copper losses depend on winding resistance R which changes according to the motor temperature. At first, torque control strategy is applied to derive 460 steady-state motor currents (i_{d}*, i_{q}*) 461 as a function of operation point 418 and dynamic model parameters 416 ξₘₒₜₒᵣ. Based on motor dynamic model parameters ξₘₒₜₒᵣ, the iron loss coefficients 466 are determined 465 as iron loss coefficients, which, combined with operation data 418, are employed to derive 470 iron loss models as functions of motor dynamic model parameters ξₘₒₜₒᵣ and operation data 418. On the other hand, given the steady-state motor currents 461, an approximate motor power 476, denoted as P_{in,ap}, is obtained at step 475 based on iron losses model 471 and an approximate motor copper loss model induced by winding resistance under ambient temperature. The approximate motor power 476 is used to approximate motor temperature 480. The motor temperature 481 is used to determine 485 an approximate motor winding resistance 486. The copper loss model 491 may be derived 490 from the approximate motor winding resistance 486. The approximate motor resistance 486 is used to determine the copper losses P_{copper} as functions of motor dynamic model parameters ξₘₒₜₒᵣ and operation data 418. The copper loss model 491, the iron losses model 471, and the mechanical power model are consolidated 492 to derive 495 the efficiency model 496 according to the formula (4) where the efficiency model 496 is as an analytical function of operation point 418 and design ξₘₒₜₒᵣ.

In some embodiments, the analytical formulas of P_{mech}, P_{cu}, P_{hyst}, P_{eddy} may be derived as follows. A max voltage V_{emf,max} which is available to overcome back electromagnetic force (back-EMF) is first derived as V_{emf,max}=u_{ub}−Rₘₐₓi_{ub}, where Rₘₐₓi_{ub} is the max voltage drop induced by the max resistance and max current of the phase winding. In some embodiments, the max resistance 486 is approximated 485 by

$${R}_{max} = {R}_{0} ( 1 + α ( {T}_{max} - {T}_{0} ) ) , \qquad ( 5 )$$

where Tₘₐₓ and T₀ are the max temperature and the ambient temperature, respectively, R₀ is the resistance at the ambient temperature, and α is a constant coefficient related to material. Given the motor dynamic model (2), the back-EMF is given by:

$${V}_{emf} = P ω \sqrt{{( {L}_{q} {i}_{q} )}^{2} + {( {Φ}_{m} + {L}_{d} {i}_{d} )}^{2}} .$$

Given operation point 418, the current minimization control strategy is applied to 460 determine steady-state motor currents 461 by solving the following problem:

$${min}_{{i}_{d} , {i}_{q}} ( {i}_{d}^{2} + {i}_{q}^{2} )$$

$$subject to$$

$${i}_{d}^{2} + {i}_{d}^{2} \leq {i}_{ub}^{2} , {V}_{emf} \leq {V}_{emf , max}$$

$$1.5 P {Φ}_{m} {i}_{q} = {τ}_{e} ,$$

which admits an analytical solution. The detailed derivation of analytical formulas of steady-state currents of motor as a function of operation point 418 is straightforward for those skilled in the art and can be derived in accordance with known methods.

In some embodiments, the hysteresis and eddy losses for a given motor design is derived as part of step 470 as

$${P}_{hyst} = \frac{{k}_{hyst} \vert ω \vert {B}_{max}^{{β}_{st}}}{2 π} {V}_{iron} \qquad ( 6 )$$

$${P}_{eddy} = \frac{8 {R}_{r o} {k}_{eddy}}{π P {w}_{tooth}} \frac{{ω}^{2}}{{( 2 π )}^{2}} {B}_{max}^{2} {V}_{iron} ,$$

where k_{hyst} and k_{eddy} are the coefficients, βₛₜ=1.8 is the Steinmetz constant, and Vᵢᵣₒₙ is the volume of iron. The coefficients k_{hyst} and k_{eddy} are dependent on motor design. According to some embodiments, a method to determine 465 the iron losses coefficients may be executed by scaling the coefficients of nominal design ξ₀ for the coefficients of design ξ. That is:

$${k}_{hyst , ξ} \approx {k}_{hyst , {ξ}_{0}} \frac{{Φ}_{m , ξ}}{{Φ}_{m , {ξ}_{0}}} , {k}_{eddy , ξ} \approx {k}_{eddy , {ξ}_{0}} \frac{{Φ}_{m , ξ}}{{Φ}_{m , {ξ}_{0}}} , \qquad ( 7 )$$

where quantities with subscripts ξ and ξ₀ are associated with design ξ and nominal design ξ₀, respectively. Here k_{hyst,ξ}_{₀} and k_{eddy,ξ}_{₀} are pre-calculated positive constants for the nominal design ξ₀.

Given iron losses (6), mechanical power P_{mech}, and the approximate copper losses P_{cu,ap}=R₀((i_{d}*)²+(i_{q}*)²) where (i_{d}*, i_{q}*) are steady-state motor currents 461, the approximate input power 476 is calculated as P_{in,ap}=P_{hyst}+P_{eddy}+P_{mech}+P_{cu,ap}.

Next, P_{in,ap} is used to 485 determine the temperature-dependent winding resistance as R=R₀(1+α(T−T₀)) with

$$T = {T}_{max} \frac{{P}_{in , ap}}{{P}_{rated}} + {T}_{0}$$

where P_{rated} is the rated power of motor. Finally, the copper loss model is derived as P_{cu}=R(i_{d}*)²+(i_{q}*)²).

The dynamic model of an n-degree of freedom (DoF) manipulator 100 can be written as follows:

$$M ( θ ) \ddot{θ} + C ( θ , \dot{θ} ) \dot{θ} + G ( θ ) = {τ}_{L} , \qquad ( 8 )$$

where θ=[θ_{L}_{₁} . . . θ_{L}_{ₖ} . . . θ_{L}_{ₙ}]^{T}∈ [symbol] , \dot{θ}, and \ddot{θ} are the angles, velocities, accelerations of links, with the units of rad, rad/s, rad/s², respectively; subscript Lₖ represents the link at the kth axis; τ_{L}=[τ_{L}_{₁}, . . . , τ_{L}_{ₙ}]^{T} is the vector of torques applied on all links; M, C and G are the link inertia matrix, Coriolis forces, and gravitational force, respectively. Constraints on the angle and velocity of the kth link are:

$${θ}_{{L}_{k} , l b} \leq {θ}_{{L}_{k}} \leq {θ}_{{L}_{k} , ub} \\ {\dot{θ}}_{{L}_{k} , l b} \leq {\dot{θ}}_{{L}_{k}} \leq {\dot{θ}}_{{L}_{k} , ub} , \qquad ( 9 )$$

where subscript lb stands for lower bound. Angles θ are referred to as configuration of the robot manipulator.

In some embodiments, the gearbox at the k+1^{th} axis has a transmission ratio Zₖ₊₁. At the k^{th} axis, the motor velocity ωₖ is proportional to the link velocity \dot{θ}_{L}_{ₖ}, i.e., ωₖ=\dot{θ}_{L}_{ₖ}. For an ideal differentiable simulator, no friction in gearbox and motor bearing is assumed, which implies τ_{L}_{ₖ}=Zₖτₖ, where τₖ is the load torque applied on the rotor shaft of the k^{th}-axis motor.

In some embodiments, the design parameters of the motor at the k^{th} axis is denoted as &k, and the design parameters of all motors are denoted as Ξ=[ξ₁^{τ}, . . . , ξₙ^{τ}]^{τ}. Let i_{d,k}, i_{q,k}, ωₖ, u_{d,k}, u_{q,k} be quantities associated with the motor at the kth axis (interchangeably, the kth motor). Denote the vectors of currents and control inputs of the k th motor as iₖ=[i_{d,k}, i_{q,k}]^{τ} and u_{K}=[u_{d,k}, u_{q,k}]^{τ}, respectively. Let i=[i₁^{τ}, . . . , iₙ^{τ}]^{τ} and u=[u₁^{τ}, . . . , uₙ^{τ}]^{τ} encapsulate the currents and control inputs of all motors, respectively. The state of the system including motors and robot manipulator is given by x=[i^{τ}, θ^{τ}, \dot{θ}^{τ}]^{τ}.

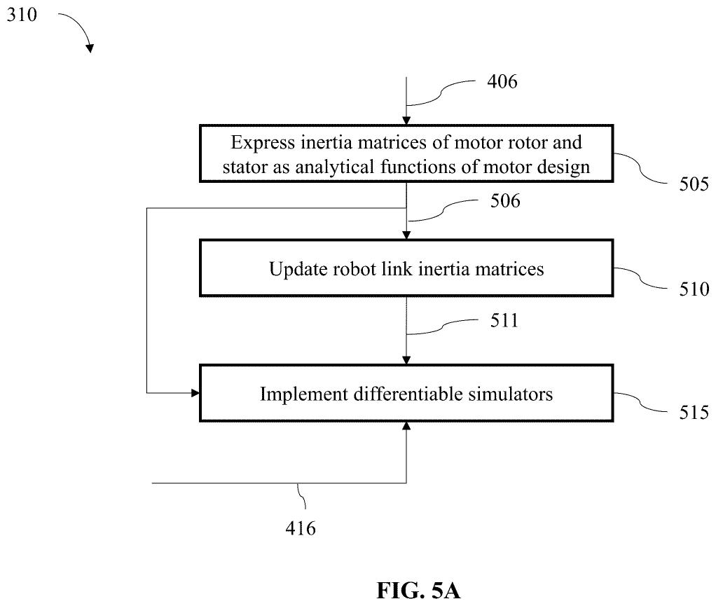

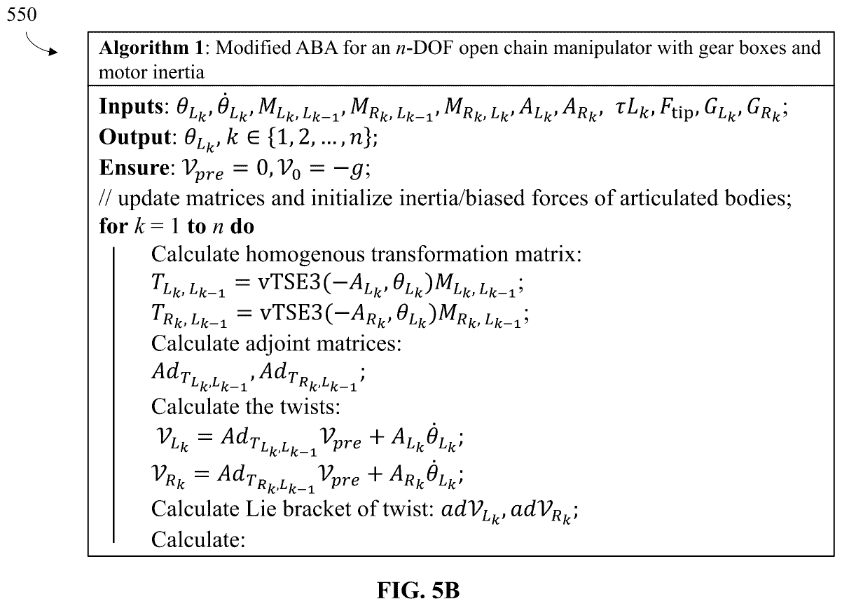

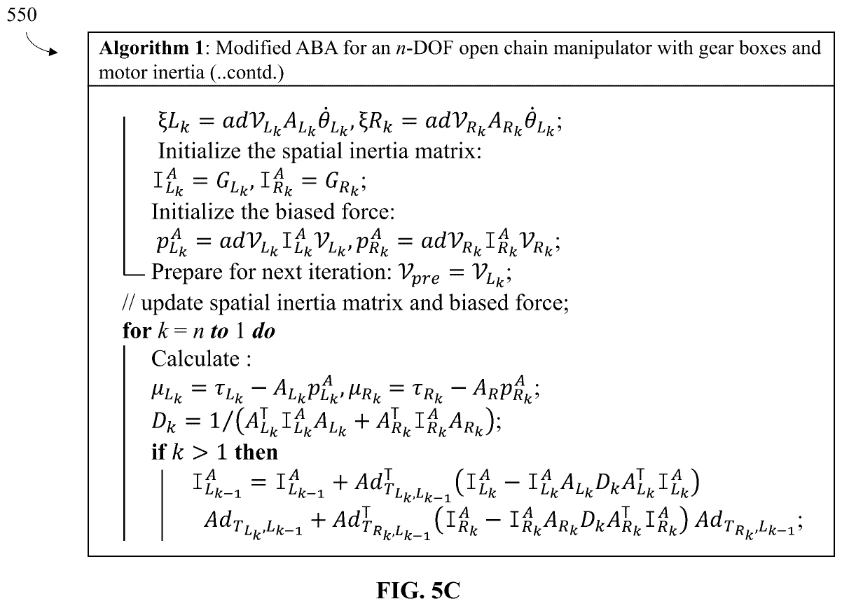

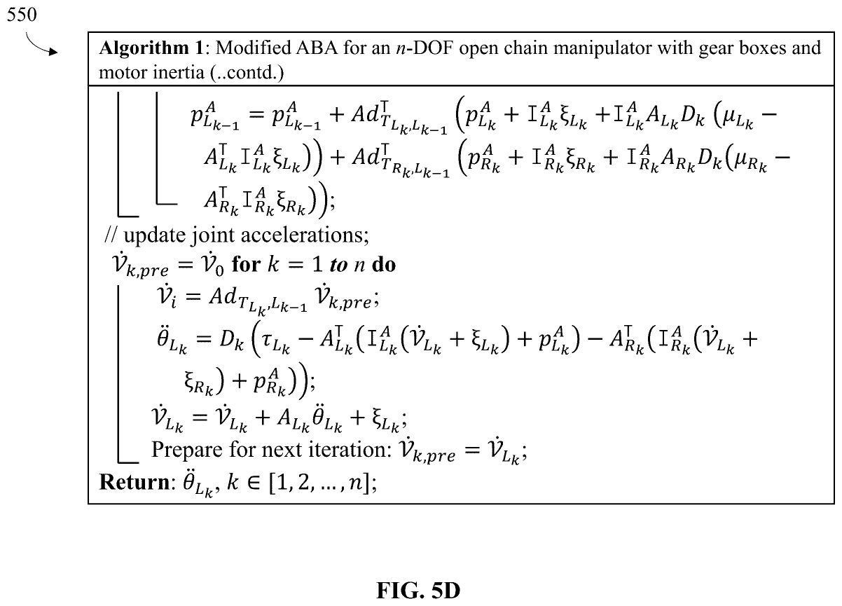

FIG. 5A illustrates some steps of a method for updating robot arm dynamics (8), as a part of robot arm dynamics modeling 310, according to motor design Ξ 406, which, equivalently, is reduced to explicitly express M, C, G are analytical matrix functions of motor design Ξ. Given design Ξ 406, the inertia matrices of rotor and stator of motors are expressed 505 as analytical functions of E. The inertia of the rotor of a motor in its principal 506 axes are

$${I}_{xx} = \frac{1}{2} {ρ}_{iron} π {R}_{ro}^{4} L and$$

$${I}_{yy} = {I}_{zz} = \frac{1}{12} {ρ}_{iron} π {R}_{ro}^{2} L ( 3 {R}_{ro}^{2} + {L}^{2} )$$

The inertia of the stator of the motor can be similarly derived, which is straightforward to those skilled in the art and thus omitted. The functions of inertia matrices 506 are used to update 510 robot link inertia matrices as analytical functions of design Ξ. Particularly, the inertia matrix function of stator of the motor at the ith-axis is incorporated into the inertia matrix function of the ith-axis link. With the updated inertia matrix functions of all links 511, inertia matrix functions of rotors and stators of all motors 506, and the motor dynamic model 416, an ideal differentiable simulator 210 can be implemented 515 by the algorithm 550 jointly illustrated in FIGS. 5B-5D.

The ideal differentiable simulator 210 implements the forward dynamics of manipulator 100 including all motor dynamic models 416 and the forward dynamics of the robot arm, which is expressed as an analytical function of design parameters Ξ. In the algorithm 550, p, A, M, G, Fₜᵢₚ, and V represent the biased force, screw axis, homogeneous transformation matrix, spatial inertia matrix, wrench at the tip, and twist, respectively. Other notations follow the description provided by the book “MODERN ROBOTICS MECHANICS, PLANNING, AND CONTROL” authored by Kevin M. Lynch and Frank C. Park, the contents of which are incorporated in entirety.

The forward dynamics of a robot arm is essentially a state space representation of a system dynamics (8): \dot{x}_{robot}=f (x_{robot}, u_{robot}) with x_{robot}=[θ^{τ}, \dot{θ}^{τ}]^{τ} being state of the robot arm and u_{robot}=τ_{L} being control input of the robot arm. The notation of forward dynamics is well-understood for those skilled in the art and can be derived suitably in accordance with known methods.

In some embodiments, a non-ideal differentiable simulator 225 may implement the algorithm 550 of FIG. 5B except that the non-ideal differentiable simulator 225 contains an additional torque term τ_{f}_{ₖ} to τ_{L}_{ₖ} for 1≤k≤n in order to characterize unmodelled dynamics such as friction.

In some embodiments, given differentiable models, any software tool supporting auto-differentiation, e.g., CasADi, may be employed to implement differentiable simulators to expedite computationally efficient optimization algorithms.

In some embodiments, the k^{th} link inertia G_{L}_{ₖ} encompasses the stator of the (k+1)^{th} motor. The motor rotor and gearbox are treated as distinct rigid bodies, with the inertia being denoted as G_{R}_{ₖ}, and all associated kinematic and dynamic quantities are updated independently. The spatial vector for gravitational acceleration is denoted as g=−[0,0,0,0,0,9.81]^{τ}.

In some embodiments, an application of interest to customers/operators may be characterized by a set of nₜ tasks 215a: [symbol] [symbol] { [symbol] ₁, [symbol] ₂, . . . , [symbol] ₙ_{ₜ}}. A task [symbol] ᵢ is distinctively described by a tuple (θ₀, θ_{f}, Mₚ), where θ₀, θ_{f}, and Mₚ are the initial configuration, the final configuration, and the inertia matrix of the payload, respectively. Initial velocity \dot{θ}(0) and final velocity \grave{θ}(t_{f}) are typically zero. For the motor currents in d-axis and q-axis corresponding to θ₀ and θ_{f}, from \dot{θ}(0)=\dot{θ}(t_{f})=0, we choose d-axis current being 0: i_{d}(0)=i_{d}(t_{f})=0. However, q-axis currents, i_{q}(0) and i_{q}(t_{f}), which reflect the necessary torques to maintain balance at the corresponding configurations, might not be zero. The necessary torques may be determined based on inverse dynamics of the manipulator 100, which further imply i_{q} by solving the nonlinear algebraic equations induced by setting the right-hand side of the motor dynamic model 416 to 0. Hence, from configurations θ₀ and θ_{f}, the initial state x₀ and final state x_{f} may be readily obtained. The application of inverse dynamics of a robot arm are straightforward for those skilled in the art and thus omitted in this description.

In some embodiments, the initial position 110a and final position 110b for a given task (application data) 215a are represented by θ₀ and θ_{f} respectively, which can be used to infer the initial state and final state. In another embodiment, the initial position 110a and final position 110b for a given task 215a are represented by initial state x₀ and final state x_{f} of system, respectively.

In some embodiments, the initial position 110a and final position 110b for a given task 215a are represented by the initial pose and final pose of the end-effector. The construction of initial configuration θ₀ and final configuration θ_{f} can be inferred by solving inverse kinematics problem, which is straightforward to those skilled in the art.

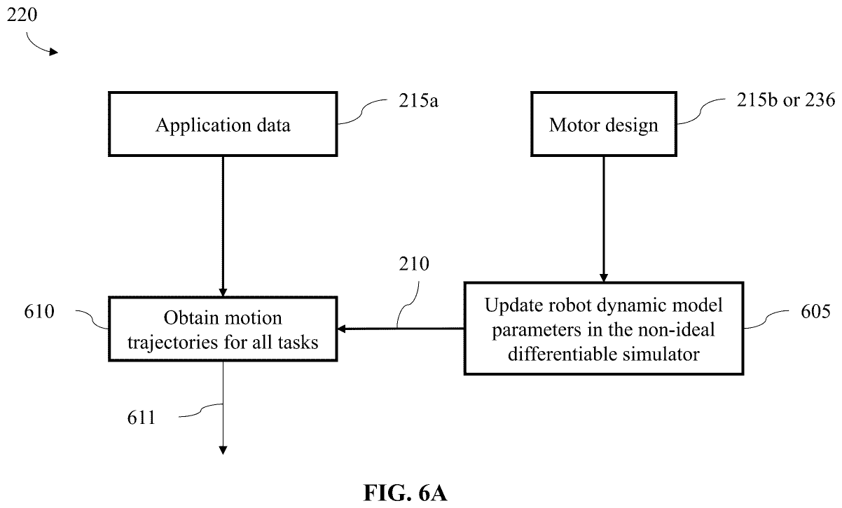

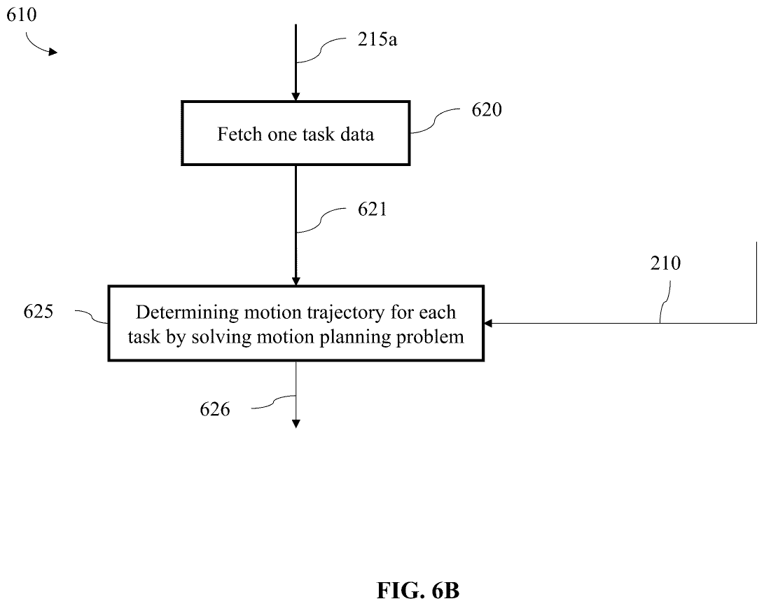

FIG. 6A discloses a method for obtaining 220 reference motion trajectory for each task in a given set of tasks [symbol] 215a where the design Ξ of all motors might be specified as an initial motor design 215b or an updated motor design 236. First, motor design Ξ 215b or 236 is passed into 605 to update the ideal differentiable simulator 210. The reference motion trajectories 611 for all tasks are obtained 610 based on the set of tasks 215a and the ideal differentiable simulator 210. In some embodiments, reference motion trajectories 611 for all nₜ tasks are given by (\hat{x}₁*, . . . , \hat{x}ₙ_{ₜ}*), or (û₁*, . . . , ûₙ_{ₜ}*), where \hat{x}ᵢ* or ûᵢ* are the reference motion trajectory for the ith task. Without causing confusion from the context, \hat{x}* or û* is referred to as the reference motion trajectory of a generic task while leaving out the subscript i.

FIG. 6B illustrates a method for obtaining 610 reference motion trajectories for all tasks, according to some embodiments. One task data 621 is first fetched 620 from the set of tasks 215a. Then the reference motion trajectory 626 for the task data 621 is determined 625, using the ideal differentiable simulator 210, by solving 625 motion planning problem. The steps of fetching 620 and the determining 625 for each task are repeated until all tasks are processed. All reference motion trajectories 626 are aggregated together to produce 611, given by (\hat{x}₁*, . . . , \hat{x}ₙ_{ₜ}*), or (û₁*, . . . , ûₙ_{ₜ}*).

In some embodiments, determining reference motion trajectory for each task 625 by solving motion planning is achieved by solving for the solution of an optimal control problem (OCP). A fixed-final-time open-loop OCP can be formulated as follows. Given dynamic models and constraints (1), (2), (3), (8), (9), initial state x₀, final state x_{f}, and final time t_{f}, determine the optimal control u* which minimizes a certain cost function J(x, u)=∫₀^{t}^{_{f}} [symbol] (x, u)dt. In one embodiment, the cost can be written as follows:

$$J = {\int }_{{t}_{o}}^{{t}_{f}} {u}^{T} Ru dt , \qquad ( 10 )$$

where R is a positive definite matrix, and t₀ and t_{f} denote the initial and final time, respectively.

According to some embodiments, one approach to the open-loop OCP is by transcribing it into a non-linear optimization problem (NLP) by discretizing the open-loop OCP over the given time interval [0, t_{f}]. The corresponding nonlinear optimization problem is formulated as follows:

$${min}_{X , U} {\sum }_{k = 0}^{N - 1} ℒ ( {X}_{k} , {U}_{k} ) \\ subject to \\ {X}_{k + 1} = f ( {X}_{k} , {U}_{k} ) , 0 \leq k \leq N - 1 \\ {c}_{I} ( {X}_{k} , {U}_{k} ) \leq 0 , 0 \leq k \leq N - 1 \\ {c}_{e} ( {X}_{k} , {U}_{k} ) = 0 , 0 \leq k \leq N - 1 \\ {X}_{0} = {x}_{0} , {X}_{N} = {x}_{f} , \qquad ( 11 )$$

where X=[x^{τ}(t₀), . . . , x^{τ}(t_{N})]^{τ} and U=[u^{τ}(t₀), . . . , u^{τ}(t_{N-1})]^{τ}, with t₀, . . . , t_{N} being obtained by discretizing the time interval [0, t_{f}] uniformly into N steps, and Xₖ=x(tₖ), Uₖ=u(tₖ); J_{d}=Σₖ₌₀^{N-1} [symbol] (Xₖ, Uₖ) is the discretized counterpart of J(x, u); f(⋅,⋅) is the discretized state dynamics induced from (2) and (8); c_{I}(⋅,⋅) and cₑ(⋅,⋅) are discretized constraints induced from (3) and (9). The non-linear optimization problem can be solved by established numerical optimization algorithms, for instance interior-point optimization algorithm. The formulation of open-loop OCP and the transcription of the corresponding nonlinear optimization problem, given a task characterized by its initial state x₀, final state x_{f} and a load Mₚ, may be carried out through known technique in the art.

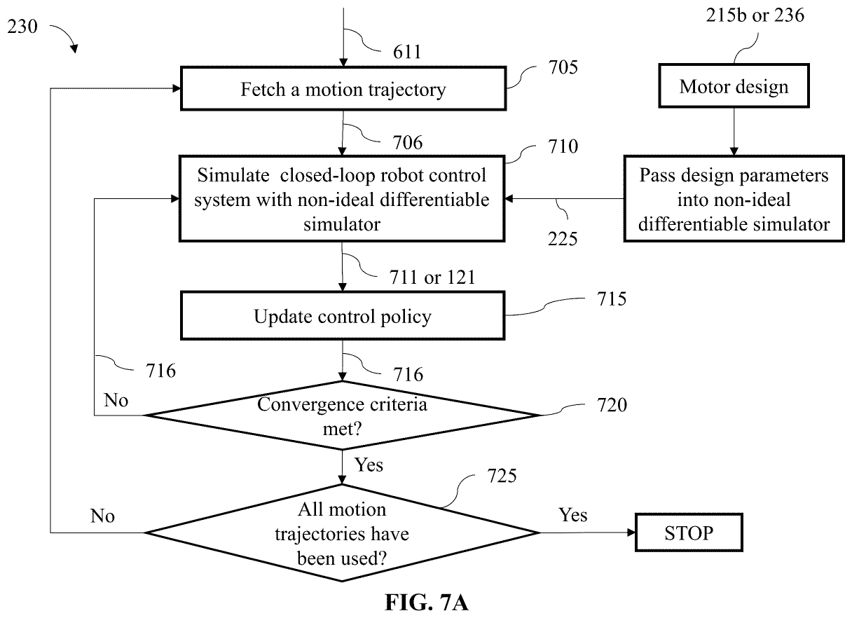

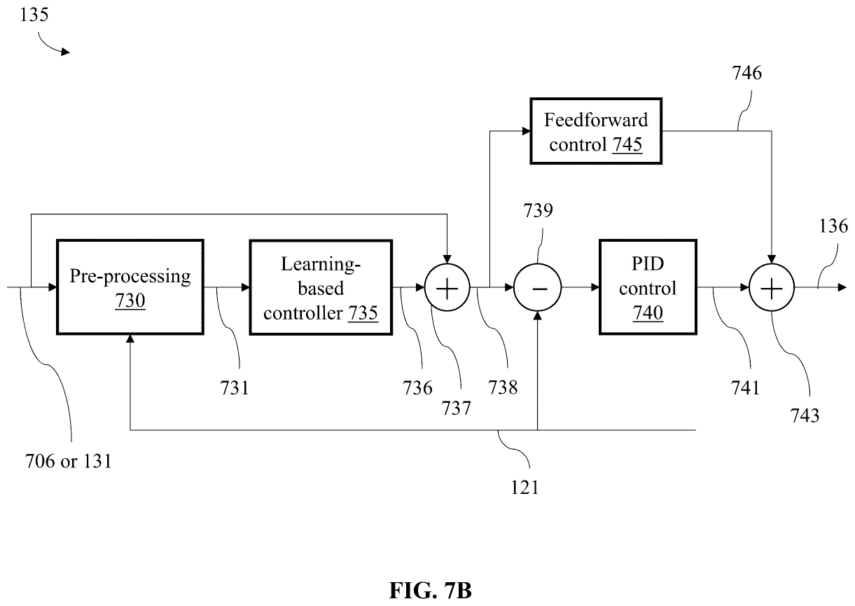

FIG. 7A illustrates a method for feedback control policy synthesis 230. Motor design parameters Ξ, either from initial design 215b or updated motor design 236, is passed into non-ideal differentiable simulator 225. A reference motion trajectory 706 is fetched 705 from the reference motion trajectories 611, which is treated as a reference trajectory 131 and submitted to the closed-loop robot control system of FIG. 1E, where the non-ideal differentiable simulator implements the forward dynamics of motors 145 and robot arm 150 and the tracking controller 135 implements an initial control policy. Simulating 710 the closed-loop robot control system gives a closed-loop motion trajectory 711 (also called the real trajectory), which is used to update control policy 715. If the convergence criteria at 720 is not met, then the updated control policy 716 is submitted to tracking controller module 135, and the simulating 710 and updating 715 steps are repeated until the convergence criteria at 720 is met; otherwise, the control policy synthesis for one reference motion trajectory 706 is completed and the control of steps move on to perform the control policy synthesis using another reference motion trajectory 706 out of 611, until all reference motion trajectories 611 have been used to synthesize control policy. With a newly fetched reference motion trajectory 706, the tracking controller module 135 is implemented with the latest synthesized control policy.

FIG. 7B illustrates a block diagram of the tracking controller 135, according to some example embodiments. A reference motion trajectory 706, used as reference trajectory 131 to the closed-loop robot control system of FIG. 1E, is first pre-processed 730 to produce auxiliary signals 731. These auxiliary signals 731 are exploited to train a learning-based controller 735. According to some embodiments, the auxiliary signals include: the reference trajectory 131, the derivative of the reference trajectory 131, an error trajectory between 131 and 121, the derivative of the error trajectory between 131 and 121. The learning-based controller outputs a correction 736 to the reference motion trajectory 131, which is combined 737 with reference trajectory 131 to obtain a virtual reference trajectory 738. The virtual reference trajectory 738 is used in feedforward control 745 to produce feedforward control torque 746. Also, the virtual reference trajectory 737 is compared 739 against the measured (real) motion trajectory 121 to yield an error motion trajectory, which is used in proportional, integral and derivative (PID) control 740 to produce a feedback control torque 741. The summation 743 of torques 746 and 741 is the torque command 136 passed to drive module 140.

In some embodiments, the measured signal 121 comprise the motor current, speed, the angles θ of all links. The reference trajectory 131 comprises the angle trajectories of all links of the robot arm. The pre-processing 730 outputs auxiliary signals consisting of: reference trajectory 131, the derivative of the reference trajectory 131, an error trajectory between 131 and 121, the derivative of the error trajectory between 131 and 121.

In some embodiment, the convergence criteria in 720 includes a condition that the errors of parameters in the latest control policy 716 and the control policy synthesized in the previous iteration are below a certain threshold. The threshold may be defined by a user-defined parameter such that the time required for the training/iterations is inversely proportional to the threshold. Alternatively, the convergence criteria in 720 is that the errors of reward (reward prediction error) of the latest control policy 716 and the reward of the control policy synthesized in the previous iteration is below a certain threshold.

In some embodiments, reinforcement learning (RL) framework may be exploited to train the learning-based controller 735 towards convergence. The RL conundrum centers on an agent that actively engages with its environment, monitoring states to determine actions that yield higher rewards. The RL agent interacts with the environment which is implemented in simulation as the non-ideal differentiable simulator 225. The learning-based policy 735 is denoted as π. The RL algorithm tries to learn policy π by evaluating the observation/measured data (auxiliary signal 731) against a certain reward function. The observation data are given by:

x=[θ*,\dot{θ}*,e*,ė*],
where θ* and \dot{θ}* are the reference motion trajectory 131 and its time derivative, respectively, e*=θ*−θ with θ is the error between the reference and measured trajectories of angles of all links, and ė* is the derivative of e*. In some embodiments, the RL goal may be to train a control policy that can track any reference trajectory under bounded disturbances, the reward function R may be designed as follow:

$$R = - ( {w}_{1} \vert e \vert + {w}_{2} \vert \dot{e} \vert + {w}_{3} \vert Δθ \vert ) \qquad ( 12 )$$

where w₁, w₂, w₃ are weighting parameters, and Δθ is 736.

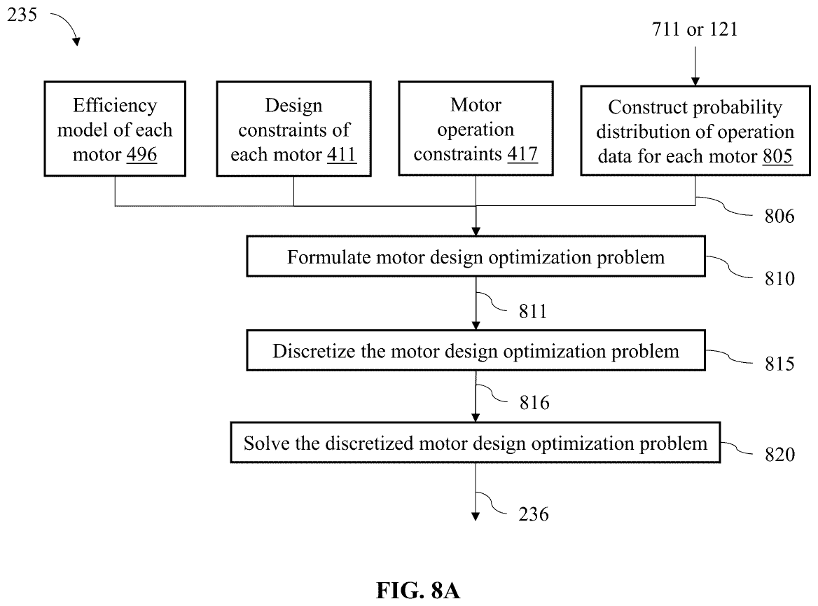

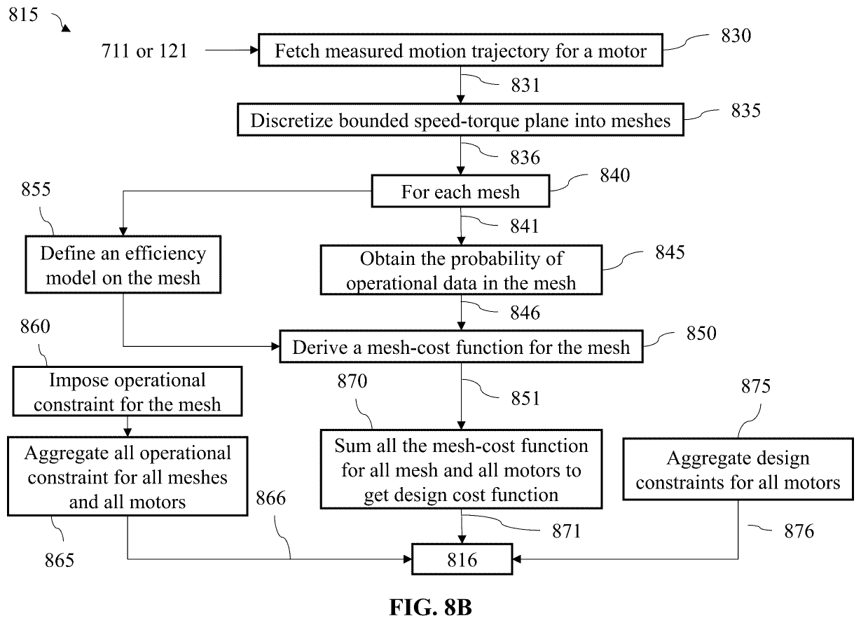

FIG. 8A illustrates a method for updating 235 motor design, according to some embodiments. Given the measured motion trajectory 711 (or equivalently measured signals 121), a probability distribution 806 of operation data is constructed 805 for each motor. A motor design optimization problem is formulated 810 based on all n probability distributions 806 of operation data, efficiency models 496 of the motors, operation constraints 417 of the motors, and design constraints 411 of all motors. The motor design optimization problem 811, defined over a 2-dimensional (2D) speed-torque plane, is discretized 815 over the speed-torque plane to yield a discretized motor design optimization problem 816, which is solved 820 to produce an update of motor design 236.

FIG. 8B illustrates a method for discretization 815 of the motor design optimization problem 811 of FIG. 8A, according to some embodiments. The discretization 815 is conducted for all motors. For illustration purposes, FIG. 8B entails a method of discretization related to one motor. However, it may be contemplated that similarly the method may be extended to all the motors. Given the measured motion trajectory 711 or equivalently measured signals 121, the measured motion trajectory related to the particular motor, denoted as 831, is fetched 830. The measured motion trajectory 831 may be used to infer the real motor velocity and torque along the trajectory, which implies a bounded region of the speed-torque plane where the motor operates. The bounded region of the speed-torque plane is discretized 835 into a plurality of meshes 836. For each mesh 840, the probability 846 of that the motor operates within the mesh 840 is determined 845. Meanwhile, the efficiency model for the mesh 840 (when the motor operates over the mesh) can be derived as 496 with the speed and torque (portion of operation point) being specified by some vertices of the mesh 840. Both the efficiency model over mesh 840 and the probability of operation data for mesh 840 are used to derive 850 the mesh-cost function 851 for the mesh 840. Repeating the aforementioned steps of 830, 835, 840, 845, 850, and 855 to obtain the mesh-cost functions for all meshes and for all motors and summing 870 all mesh-cost functions to get the cost function 871 for all motors. Meanwhile, design and operation constraints should be imposed for each mesh, and design and operation constraints for all meshes and all motors are aggregated 865 and 875 to give aggregated design constraint 866 and aggregated operation constraints 876. The discretized motor design optimization problem 816 is well-defined as a combination of aggregated cost function 871, aggregated operational constraints 865, and aggregated design constraints 876.

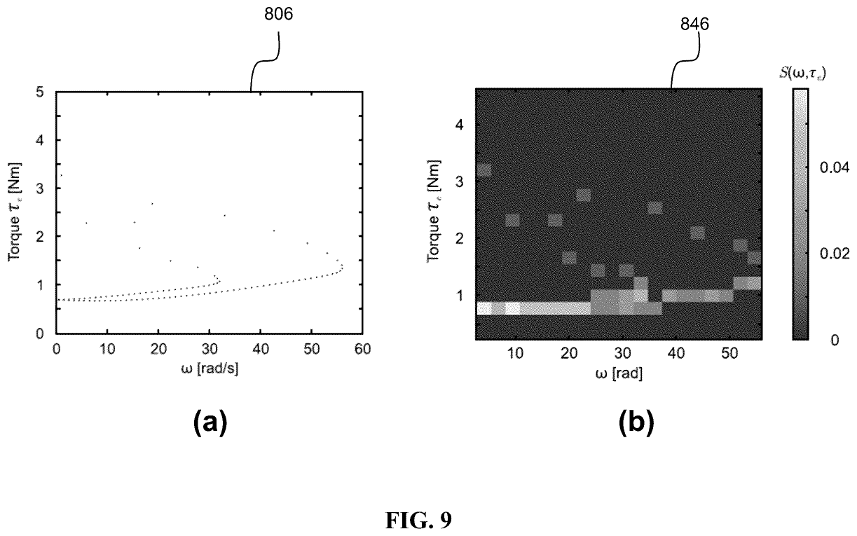

According to some embodiments, for k^{th} motor, its operational distribution Sₖ(ω, τₑ) over the speed-torque plane based on measured motion trajectories 711 or 121 (u₁, . . . , uₙ_{ₜ}) or (x₁, . . . , xₙ_{ₜ}) is constructed 805 as follows. It is known that uᵢ is represented by a sequence of uᵢ(t_{w}), with 0≤w≤N−1, and at every time step, uᵢ(t_{w}) uniquely defines the operational point of each motor on the speed-torque plane. Hence from ûᵢ, Sₖ(ω, τₑ) for 1≤k≤n, where Sₖ(ω, τₑ)=1 may be constructed at the N operational points and 0 otherwise. The plot (a) of FIG. 9 shows an example of Sₖ(ω, τₑ) from uᵢ as 806. Given all motions (u₁, . . . , uₙ_{ₜ}), one can obtain the operational distribution Sₖ(ω, τₑ) comprising Nnₜ points on the speed-torque plane, where N is the number of time steps that the discretization of time period [0, t_{f}] yields.

Given the distributions Sₖ(ω, τₑ) for 1≤k≤n, the motor design is updated by maximizing the overlaps between the distributions Sₖ(ω, τₑ) and the efficiency map of motor for all 1≤k≤n. This is achieved by solving the following optimization problem 811:

$${min}_{Ξ} {J}_{motor} ( Ξ , {u}_{1} , ⋯ , {u}_{{n}_{t}} ) \qquad ( 13 )$$

subject to (1), (3)
where Jₘₒₜₒᵣ(Ξ, u₁, . . . , uₙ_{ₜ})=Σₖ₌₁ⁿ [symbol] Sₖ(ω, τₑ) (1−ηₖ(ω, τₑ, ξₖ))dτₑdω, ηₖ, admitting the formula (4), represents the efficiency of the k^{th} motor, and [symbol] ₖ is the support of Sₖ(ω, τₑ) in the speed-torque plane. Note that for the k^{th} motor, design and operational constraints, (3) and (1), are imposed on every operation point over [symbol] ₖ, which induces an infinite number of constraints and thus impractical.

The motor design optimization problem (13), or 811 in FIG. 8A, involves the integration of Sₖ(ω, τₑ) (1−ηₖ(ω, τₑ, ξₖ)) over the 2D speed-torque plane.

One embodiment of discretization 815 of the motor design problem 811 is given as follows. The domain [symbol] k is discretized into a mesh with [symbol] × [symbol] where the ijth mesh covers the region [symbol] ₖ_{ᵢⱼ}: [ωⱼ, ωⱼ₊₁]×[τᵢ, τᵢ₊₁]. Then the probability that the k^{th} motor operates within [symbol] ₖ_{ᵢⱼ} is given by

$${\int }_{{𝒟}_{{k}_{ij}}} {S}_{k} ( ω , {τ}_{e} ) d {τ}_{e} d ω ,$$

which can be approximated 845 as

$${S}_{{𝒟}_{{k}_{ij}}} = {N}_{{𝒟}_{{k}_{ij}}} / ( {Nn}_{t} )$$

with

$${N}_{{𝒟}_{{k}_{ij}}}$$

being the number of operational points in [symbol] ₖ_{ᵢⱼ}. The plot (b) labeled as 846 in FIG. 9 visualizes the discretized counterpart of Sₖ(ω, τₑ) in plot (a) of FIG. 9 with [symbol] =20.

The efficiency model ηₖ(ω, τₑ, ξₖ) for the mesh [symbol] is defined 855 as

$${η}_{{𝒟}_{{k}_{ij}}} = {η}_{k} ( {ω}_{j + 1} , {τ}_{i + 1} , {ξ}_{k} ) .$$

Hence the mesh-cost function 851 is derived as follows:

$${\int }_{{𝒟}_{{k}_{ij}}} {S}_{k} ( ω , {τ}_{e} ) d {τ}_{e} d ω \approx {S}_{{𝒟}_{{k}_{ij}}} ( 1 - {η}_{{𝒟}_{{k}_{ij}}} ) .$$

The summation of all mesh-cost functions for all meshes and motors, equivalently the discretized counterpart of cost function in (13), can be written as follows:

$${\sum }_{k = 1}^{n} {\int }_{{𝒟}_{k}} {S}_{k} ( ω , {τ}_{e} ) ( 1 - {η}_{k} ( ω , {τ}_{e} , {ξ}_{k} ) ) d {τ}_{e} d ω \approx {\sum }_{k = 1}^{n} {\sum }_{i = 1}^{{N}_{{𝒟}_{k}}} {\sum }_{j = 1}^{{N}_{{𝒟}_{k}}} {S}_{{𝒟}_{{k}_{ij}}} ( 1 - {η}_{{𝒟}_{{k}_{ij}}} ) . \qquad ( 14 )$$

Note that in (14),

$${S}_{{𝒟}_{{k}_{ij}}}$$

is a numerical value whereas

$${η}_{{𝒟}_{{k}_{ij}}}$$

is a differentiable function w.r.t. ξₓ for a given operational point (ω, τₑ).

In some embodiments, the motor design problem tries to determine the motor design Ξ by minimizing

$${J}_{motor} ( Ξ , {u}_{1} , … , {u}_{{n}_{t}} ) = {\sum }_{k = 1}^{n} {\int }_{{𝒟}_{k}} {S}_{k} ( ω , {τ}_{e} ) {P}_{i n} ( 1 - {η}_{k} ( ω , {τ}_{e} , {ξ}_{k} ) ) d {τ}_{e} d ω ,$$

which means to find the optimal motor design giving the least energy consumption for the applications characterized by the set of all tasks [symbol] .

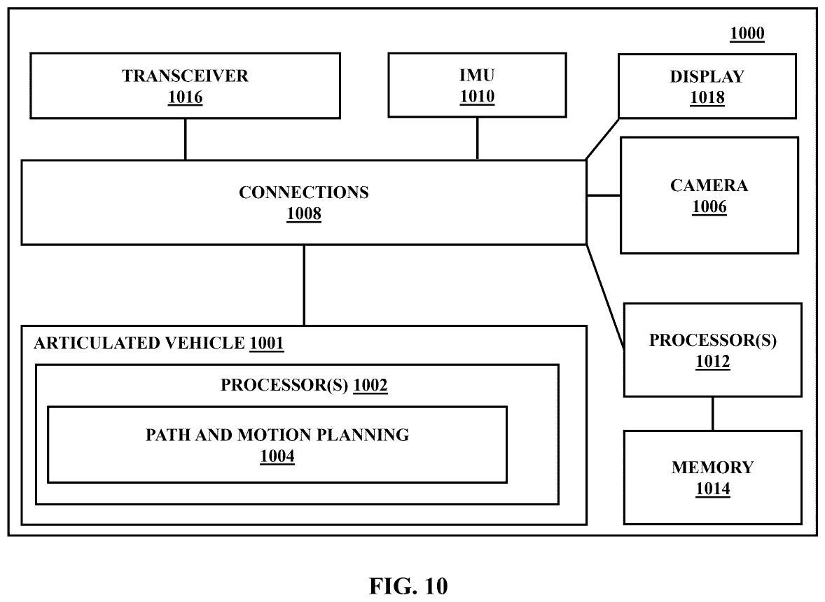

FIG. 10 illustrates some components of an engineering system 1000 for joint designing of motors, tracking controller, and motion planner for a given application defined as set of tasks, according to some embodiments. The engineering system 1000 comprises communication interfaces such as a transceiver 1016, an inertial measurement unit (IMU) 1010, output interfaces such as a display 1018, one or more sensors such as a camera 1006, computational circuitry realized through one or more processors 1012 and memory 1014. One or more connection buses 1008 may couple the components of the engineering system 1000 with each other. According to some embodiments, the engineering system 1000 may also be coupled with an articulated vehicle 1001. The vehicle 1001 comprises suitable processing circuitry realized through processors 1002 and memory that stores a path and motion planning module 1004.

According to some embodiments, the modules described with reference to FIGS. 2A-9 may be executed by the processing/computation circuitry of the engineering system 1000 to jointly designing actuators and control for robotic manipulators in accordance with various embodiments described herein.

The above description provides exemplary embodiments only, and is not intended to limit the scope, applicability, or configuration of the disclosure. Rather, the above description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the above description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments. Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

What is claimed is:

1. An engineering system, comprising: at least one processor; and a memory having instructions stored thereon that, when executed by at least one processor, cause the system to:
collect a plurality of tasks for a manipulator actuated by one or multiple actuators including a motor;
determine, jointly and in interdependence on each other, structural parameters of the motor, a plurality of reference trajectories of the motor for actuating the manipulator to perform the plurality of tasks, and parameters of a feedback control policy for the manipulator, to increase overlap between a probability distribution of values of operational data of the motor operating according to different real trajectories from a plurality of real trajectories and an efficiency map of the motor defined in a domain of the operational data of the motor; and
output the structural parameters of the motor, the feedback control policy, and the plurality of reference trajectories for performing the plurality of tasks.

2. The engineering system of claim 1, wherein the processor is further configured to:
generate a design of the motor according to the structural parameters;
compute the plurality of reference trajectories for the motor to actuate the manipulator for performing the plurality of tasks; and
determine parameters of the feedback control policy which commands the motor such that the manipulator follows the plurality of reference trajectories.

3. The engineering system of claim 1, wherein the domain of the operational data of the motor is a two-dimensional space defined by speed and torque of the motor.

4. The engineering system of claim 1, wherein the structural parameters of the motor define one or a combination of a permanent magnet thickness of the motor, a tooth width of the motor, a tooth height of the motor, and a slot opening of the motor.

5. The engineering system of claim 1, wherein each of the plurality of reference trajectories of the motor is defined by one or a combination of a state of the motor as a function of time, a control command to the motor as a function of time or a state of the manipulator as a function of time.

6. The engineering system of claim 1, wherein the processor is configured to determine the structural parameters of the motor, the parameters of the feedback control policy, and the plurality of reference trajectories of the motor jointly and in interdependence on each other as optimization parameters of an alternative optimization.

7. The engineering system of claim 1, wherein the processor is configured to iteratively determine the structural parameters, the parameters of the feedback control policy, and the plurality of reference trajectories of the motor until a termination condition is met, wherein, to perform a current iteration, the processor is configured to:
determine current reference trajectories for the plurality of tasks that optimize a cost function based on an ideal differentiable simulator characterizing the motor and manipulator dynamics, wherein in the current iteration, the motor has values of the structural parameters determined during a previous iteration, and the motor and manipulator dynamic model parameters are updated based on values of the structural parameters determined during the previous iteration;
train the feedback control policy to optimize a reward function indicating tracking performance of a manipulator control system during execution of the current reference trajectories, wherein the manipulator control system produces the plurality of real trajectories, and wherein the manipulator control system comprises at least the feedback control policy to be trained, a trajectory tracking controller, and a non-ideal simulator characterizing the motor and manipulator dynamics subject to uncertainties;
determine a current probability distribution of values of operational data of the motor operating according to the real trajectories; and
update the values of the structural parameters of the motor for the current iteration to increase the overlap of the efficiency map of the motor with the updated values of the structural parameters and the current probability distribution of values of the operational data of the motor.

8. The engineering system of claim 7, wherein the termination condition includes a condition that an error between structural parameters in the current iteration and the structural parameters determined during a previous iteration is below a threshold.

9. The engineering system of claim 8, wherein the threshold is defined as a sum of squares of the error.

10. The engineering system of claim 1, wherein to determine the reference trajectories for the plurality of tasks that optimize a cost function, the processor is configured to solve a motion planning problem using an ideal differentiable simulator where the dynamical models of the motor and manipulator are updated according to the latest structural parameters of the motor.

11. The engineering system of claim 1, wherein the processor determines the efficiency map of the motor according to design parametrization of 2D geometry of the motor and one or more operational constraints of the motor.

12. The engineering system of claim 1, wherein the processor is configured to determine the parameters of the feedback control policy for controlling the motor jointly and interdependently with the structural parameters of the motor to track the plurality of reference trajectories of the motor.

13. The engineering system of claim 12, wherein the feedback control policy includes a combination of a soft-actor-critic neural network and a classic position trajectory controller, wherein parameters of the soft-actor-critic neural network are updated according to the reference trajectories and the real trajectories to optimize a reward function indicating a degree of overlap between the real trajectories and the reference trajectories, and wherein the classic position trajectory controller comprises at least a feedforward controller and a proportional, integral and derivative (PID) controller.

14. The engineering system of claim 12, wherein the parameters of the soft-actor-critic neural network are updated by:
fetching a reference trajectory of the plurality of reference trajectories;
updating the parameters of the soft-actor-critic neural network by simulating a manipulator control system to track the fetched reference trajectory until the parameters converge; and
repeating the fetching and the updating until all reference trajectories have been used to update the parameters of the soft-actor-critic neural network.

15. The engineering system of claim 12, wherein the parameters of the soft-actor-critic neural network are updated by:
fetching a reference trajectory of the plurality of reference trajectories;
updating the parameters of the soft-actor-critic neural network by simulating a manipulator control system to track the fetched reference trajectory; and
repeating the fetching and the updating until the parameters of the soft-actor-critic neural network converge.

16. A computer-implemented method for jointly designing actuators and control for a robotic manipulator, the method comprising:
collecting a plurality of tasks for the manipulator actuated by one or multiple actuators including a motor;
determining, jointly and in interdependence on each other, structural parameters of the motor, a plurality of reference trajectories of the motor for actuating the manipulator to perform the plurality of tasks and parameters of a feedback control policy for the manipulator, to increase overlap between a probability distribution of values of operational data of the motor operating according to different real trajectories from a plurality of real trajectories and an efficiency map of the motor defined in a domain of the operational data of the motor; and
outputting the structural parameters of the motor, the feedback control policy, and the plurality of reference trajectories for performing the plurality of tasks.

17. The method of claim 16, wherein the structural parameters of the motor define one or a combination of a permanent magnet thickness of the motor, a tooth width of the motor, a tooth height of the motor, and a slot opening of the motor.

18. The method of claim 16, wherein each of the plurality of reference trajectories of the motor is defined by one or a combination of a state of the motor as a function of time, a control command to the motor as a function of time, or a state of the manipulator as a function of time.

19. The method of claim 16, wherein the structural parameters of the motor, the parameters of the feedback control policy, and the plurality of reference trajectories of the motor are determined jointly and in interdependence on each other as optimization parameters of an alternative optimization.

20. The method of claim 16, wherein the structural parameters of the motor, the parameters of the feedback control policy, and the plurality of reference trajectories of the motor are determined iteratively until a termination condition is met, wherein a current iteration includes:
determining current reference trajectories for the plurality of tasks that optimize a cost function based on an ideal differentiable simulator characterizing the motor and manipulator dynamics, wherein in the current iteration, the motor has values of the structural parameters determined during a previous iteration, and the motor and manipulator dynamic model parameters are updated based on values of the structural parameters determined during the previous iteration;
training the feedback control policy to optimize a reward function indicating tracking performance of a manipulator control system during execution of the current reference trajectories, wherein the manipulator control system produces the plurality of real trajectories, and wherein the manipulator control system comprises at least the feedback control policy to be trained, a trajectory tracking controller, and a non-ideal simulator characterizing the motor and manipulator dynamics subject to uncertainties;
determining a current probability distribution of values of operational data of the motor operating according to the real trajectories; and
updating the values of the structural parameters of the motor for the current iteration to increase the overlap of the efficiency map of the motor with the updated values of the structural parameters and the current probability distribution of values of the operational data of the motor.
